(19) United States
(12) Patent Application Publication
(10) Pub. No.: US 2024/0134044 A1
(43) Pub. Date: Apr. 25, 2024

(54) LASER SOURCE WITH MULTIPLE SEEDS FOR LIDAR

(71) Applicant: Innovusion, Inc, Sunnyvale, CA (US)

(72) Inventors: Yufeng Li, Milpitas, CA (US); Orkhongua Batjargal, San Jose, CA (US); Peng Wan, San Jose, CA (US); Yimin Li, Cupertino, CA (US); Junwei Bao, Los Altos, CA (US); Jia Ge, Milpitas, CA (US); Yang Han, Cupertino, CA (US); Ching-Ling Meng, Sunnyvale, CA (US); Ning-Yi Wang, Fremont, CA (US)

(73) Assignee: Innovusion, Inc, Sunnyvale, CA (US)

(21) Appl. No.: 18/383,426

(22) Filed: Oct. 23, 2023

Related U.S. Application Data
(60) Provisional application No. 63/418,936, filed on Oct. 24, 2022.

(51) Int. Cl. G01S 17/10; G01S 7/481; G01S 17/931

(52) U.S. Cl. CPC G01S 17/10; G01S 7/4817; G01S 17/931

(57) ABSTRACT

A laser device for providing light to a LiDAR system comprises a plurality of seed lasers configured to provide multiple seed light beams, at least two of the seed light beams having different wavelengths. An amplifier is optically coupled to the plurality of seed lasers to receive the multiple seed light beams. A power pump is configured to provide pump power to the amplifier, where the amplifier amplifies the multiple seed light beams using the pump power to obtain amplified light beams. A second light coupling unit is configured to demultiplex the amplified light beams to obtain a plurality of output light beams, at least two of the output light beams having wavelengths corresponding to the wavelengths of the at least two seed light beams.

### CROSS-REFERENCE TO RELATED APPLICATIONS

This application claims priority to U.S. Provisional Patent Application Ser. No. 63/418,936, filed Oct. 24, 2022, entitled “Laser Source with Multiple Seeds for Lidar” the content of which is hereby incorporated by reference in its entirety for all purposes.

### FIELD OF THE TECHNOLOGY

This disclosure relates generally to light ranging and detection and, more particularly, to a laser device having multiple seed lasers for providing light to a LiDAR system.

### BACKGROUND

Light detection and ranging (LiDAR) systems use light pulses to create an image or point cloud of the external environment. Some typical LiDAR systems include a light source, a light transmitter, a light steering system, and a light detector. The light source generates a light beam that is directed by the light steering system in particular directions when being transmitted from the LiDAR system. When a transmitted light beam is scattered by an object, a portion of the scattered light returns to the LiDAR system as a return light pulse. The light detector detects the return light pulse. Using the difference between the time that the return light pulse is detected and the time that a corresponding light pulse in the light beam is transmitted, the LiDAR system can determine the distance to the object using the speed of light. The light steering system can direct light beams along different paths to allow the LiDAR system to scan the surrounding environment and produce images or point clouds. LiDAR systems can also use techniques other than time-of-flight and scanning to measure the surrounding environment.

### SUMMARY

Systems and methods described in this disclosure provide a multiple-seed laser device for providing light to a LiDAR system. A typical pulsed fiber laser source includes a single wavelength seed laser. However, for many LiDAR applications, it is beneficial to have two scanners with two different wavelengths, e.g., one to cover the overall field-of-view (FOV) and the other to cover a smaller region-of-interest (ROI). Instead of having two separate laser sources, the embodiments herein allow for multiple (two or more) seed lasers to share common amplifier sections. This solution saves space and cost and also supports flexible device configurations.

In one embodiment, a laser device for providing light to a light ranging and detection (LiDAR) system is provided. The device comprises a plurality of seed lasers configured to provide multiple seed light beams, at least two of the seed light beams having different wavelengths. A first light coupling unit is optically coupled to the plurality of seed lasers and configured to receive the multiple seed light beams. An amplifier is optically coupled to the first light coupling unit to receive the multiple seed light beams, and a power pump is configured to provide pump power to the amplifier, where the amplifier amplifies the multiple seed light beams using the pump power to obtain amplified light beams. A second light coupling unit is configured to demultiplex the amplified light beams to obtain a plurality of output light beams, at least two of the output light beams having wavelengths corresponding to the wavelengths of the at least two seed light beams.

In one embodiment, a method of providing laser light to a light ranging and detection (LiDAR) system is provided. The method comprises receiving, from a plurality of seed lasers at a first light coupling unit, multiple seed light beams, at least two of the seed light beams having different wavelengths; generating, by a power pump, pump laser light to provide pump power; amplifying, by an amplifier optically coupled to the first light coupling unit and the power pump, the multiple seed light beams using the pump power to obtain amplified light beams; and demultiplexing, by a second light coupling unit optically coupled to the amplifier, the amplified light beams to obtain a plurality of output light beams, at least two of the output light beams having wavelengths corresponding to the wavelengths of the at least two seed light beams.

### BRIEF DESCRIPTION OF THE DRAWINGS

The present application can be best understood by reference to the figures described below taken in conjunction with the accompanying drawing figures, in which like parts may be referred to by like numerals.

FIG. 1 illustrates one or more exemplary LiDAR systems disposed or included in a motor vehicle.

FIG. 2 is a block diagram illustrating interactions between an exemplary LiDAR system and multiple other systems including a vehicle perception and planning system.

FIG. 3 is a block diagram illustrating an exemplary LiDAR system.

FIG. 4 is a block diagram illustrating an exemplary fiber-based laser source.

FIGS. 5A-5C illustrate an exemplary LiDAR system using pulse signals to measure distances to objects disposed in a field-of-view (FOV).

FIG. 6 is a block diagram illustrating an exemplary apparatus used to implement systems, apparatus, and methods in various embodiments.

FIG. 7 is a diagram illustrating an example dual scanner LiDAR system.

FIG. 8 illustrates a conventional single stage pre-amplifier.

FIG. 9A is a block diagram illustrating an example of a multiple-seed laser device in accordance with an embodiment.

FIG. 9B is a block diagram illustrating an example of a multiple-seed laser device in accordance with an embodiment.

FIG. 10 is a flow diagram illustrating an example method of providing laser light from multiple seed lasers to a LiDAR system.

### DETAILED DESCRIPTION

To provide a more thorough understanding of the present invention, the following description sets forth numerous specific details, such as specific configurations, parameters, examples, and the like. It should be recognized, however, that such description is not intended as a limitation on the scope of the present invention but is intended to provide a better description of the exemplary embodiments.

Throughout the Specification and Claims, the Following Terms Take the Meanings Explicitly Associated Herein, Unless the Context Clearly Dictates Otherwise:

The phrase “in one embodiment” as used herein does not necessarily refer to the same embodiment, though it may. Thus, as described below, various embodiments of the disclosure may be readily combined, without departing from the scope or spirit of the invention.

As used herein, the term “or” is an inclusive “or” operator and is equivalent to the term “and/or,” unless the context clearly dictates otherwise.

The term “based on” is not exclusive and allows for being based on additional factors not described unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of a networked environment where two or more components or devices are able to exchange data, the terms “coupled to” and “coupled with” are also used to mean “communicatively coupled with”, possibly via one or more intermediary devices.

Although the following description uses terms “first,” “second,” etc. to describe various elements, these elements should not be limited by the terms. These terms are only used to distinguish one element from another. For example, a first seed laser could be termed a second seed laser and, similarly, a second seed laser could be termed a first seed laser, without departing from the scope of the various described examples. The first seed laser and the second seed laser can both be seed lasers and, in some cases, can be separate and different seed lasers.

In addition, throughout the specification, the meaning of “a”, “an”, and “the” includes plural references, and the meaning of “in” includes “in” and “on”.

Although some of the various embodiments presented herein constitute a single combination of inventive elements, it should be appreciated that the inventive subject matter is considered to include all possible combinations of the disclosed elements. As such, if one embodiment comprises elements A, B, and C, and another embodiment comprises elements B and D, then the inventive subject matter is also considered to include other remaining combinations of A, B, C, or D, even if not explicitly discussed herein. Further, the transitional term “comprising” means to have as parts or members, or to be those parts or members. As used herein, the transitional term “comprising” is inclusive or open-ended and does not exclude additional, unrecited elements or method steps.

Throughout the following disclosure, numerous references may be made regarding servers, services, interfaces, engines, modules, clients, peers, portals, platforms, or other systems formed from computing devices. It should be appreciated that the use of such terms is deemed to represent one or more computing devices having at least one processor (e.g., ASIC, FPGA, PLD, DSP, x86, ARM, RISC-V, ColdFire, GPU, multi-core processors, etc.) configured to execute software instructions stored on a computer readable tangible, non-transitory medium (e.g., hard drive, solid state drive, RAM, flash, ROM, etc.). For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable medium storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, a circuit-switched network, the Internet, LAN, WAN, VPN, or other type of network.

As used in the description herein and throughout the claims that follow, when a system, engine, server, device, module, or other computing element is described as being configured to perform or execute functions on data in a memory, the meaning of “configured to” or “programmed to” is defined as one or more processors or cores of the computing element being programmed by a set of software instructions stored in the memory of the computing element to execute the set of functions on target data or data objects stored in the memory.

It should be noted that any language directed to a computer should be read to include any suitable combination of computing devices or network platforms, including servers, interfaces, systems, databases, agents, peers, engines, controllers, modules, or other types of computing devices operating individually or collectively. One should appreciate the computing devices comprise a processor configured to execute software instructions stored on a tangible, non-transitory computer readable storage medium (e.g., hard drive, FPGA, PLA, solid state drive, RAM, flash, ROM, etc.). The software instructions configure or program the computing device to provide the roles, responsibilities, or other functionality as discussed below with respect to the disclosed apparatus. Further, the disclosed technologies can be embodied as a computer program product that includes a non-transitory computer readable medium storing the software instructions that causes a processor to execute the disclosed steps associated with implementations of computer-based algorithms, processes, methods, or other instructions. In some embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges among devices can be conducted over a packet-switched network, the Internet, LAN, WAN, VPN, or other type of packet switched network; a circuit switched network; cell switched network; or other type of network.

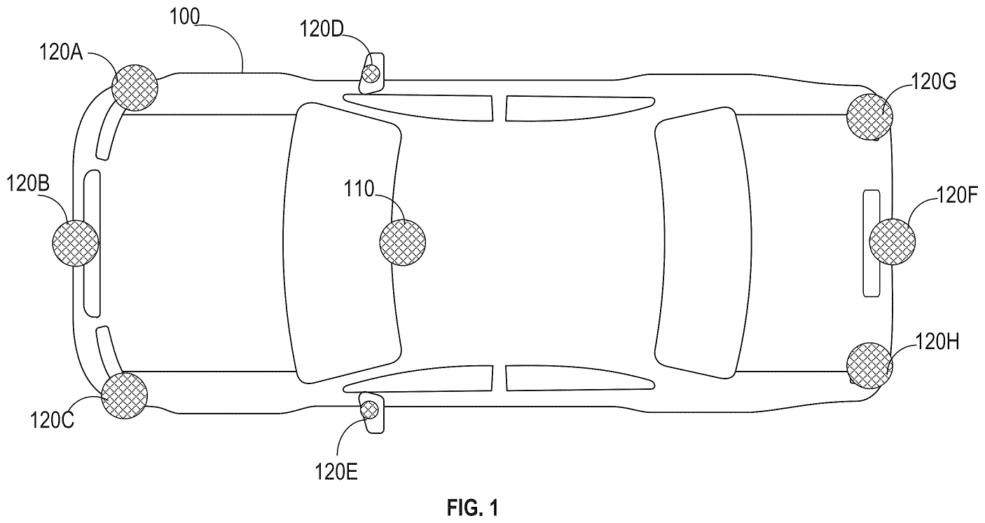

FIG. 1 illustrates one or more exemplary LiDAR systems 110 disposed or included in a motor vehicle 100. Motor vehicle 100 can be a vehicle having any automated level. For example, motor vehicle 100 can be a partially automated vehicle, a highly automated vehicle, a fully automated vehicle, or a driverless vehicle. A partially automated vehicle can perform some driving functions without a human driver's intervention. For example, a partially automated vehicle can perform blind-spot monitoring, lane keeping and/or lane changing operations, automated emergency braking, smart cruising and/or traffic following, or the like. Certain operations of a partially automated vehicle may be limited to specific applications or driving scenarios (e.g., limited to only freeway driving). A highly automated vehicle can generally perform all operations of a partially automated vehicle but with less limitations. A highly automated vehicle can also detect its own limits in operating the vehicle and ask the driver to take over the control of the vehicle when necessary. A fully automated vehicle can perform all vehicle operations without a driver's intervention but can also detect its own limits and ask the driver to take over when necessary. A driverless vehicle can operate on its own without any driver intervention.

In typical configurations, motor vehicle 100 comprises one or more LiDAR systems 110 and 120A-F. Each of LiDAR systems 110 and 120A-F can be a scanning-based LiDAR system and/or a non-scanning LiDAR system (e.g., a flash LiDAR). A scanning-based LiDAR system scans one or more light beams in one or more directions (e.g., horizontal and vertical directions) to detect objects in a field-of-view (FOV). A non-scanning based LiDAR system transmits laser light to illuminate an FOV without scanning. For example, a flash LiDAR is a type of non-scanning based LiDAR system. A flash LiDAR can transmit laser light to simultaneously illuminate an FOV using a single light pulse or light shot.

A LiDAR system is often an essential sensor of a vehicle that is at least partially automated. In one embodiment, as shown in FIG. 1, motor vehicle 100 may include a single LiDAR system 110 (e.g., without LiDAR systems 120A-F) disposed at the highest position of the vehicle (e.g., at the vehicle roof). Disposing LiDAR system 110 at the vehicle roof facilitates a 360-degree scanning around vehicle 100. In some other embodiments, motor vehicle 100 can include multiple LiDAR systems, including two or more of systems 110 and/or 120A-F. As shown in FIG. 1, in one embodiment, multiple LiDAR systems 110 and/or 120A-F are attached to vehicle 100 at different locations of the vehicle. For example, LiDAR system 120A is attached to vehicle 100 at the front right corner; LiDAR system 120B is attached to vehicle 100 at the front center; LiDAR system 120C is attached to vehicle 100 at the front left corner; LiDAR system 120D is attached to vehicle 100 at the right-side rear view mirror; LiDAR system 120E is attached to vehicle 100 at the left-side rear view mirror; and/or LiDAR system 120F is attached to vehicle 100 at the back center. In some embodiments, LiDAR systems 110 and 120A-F are independent LiDAR systems having their own respective laser sources, control electronics, transmitters, receivers, and/or steering mechanisms. In other embodiments, some of LiDAR systems 110 and 120A-F can share one or more components, thereby forming a distributed sensor system. In one example, optical fibers are used to deliver laser light from a centralized laser source to all LiDAR systems. It is understood that one or more LiDAR systems can be distributed and attached to a vehicle in any desired manner and FIG. 1 only illustrates one embodiment. As another example, LiDAR systems 120D and 120E may be attached to the B-pillars of vehicle 100 instead of the rear-view mirrors. As another example, LiDAR system 120B may be attached to the windshield of vehicle 100 instead of the front bumper.

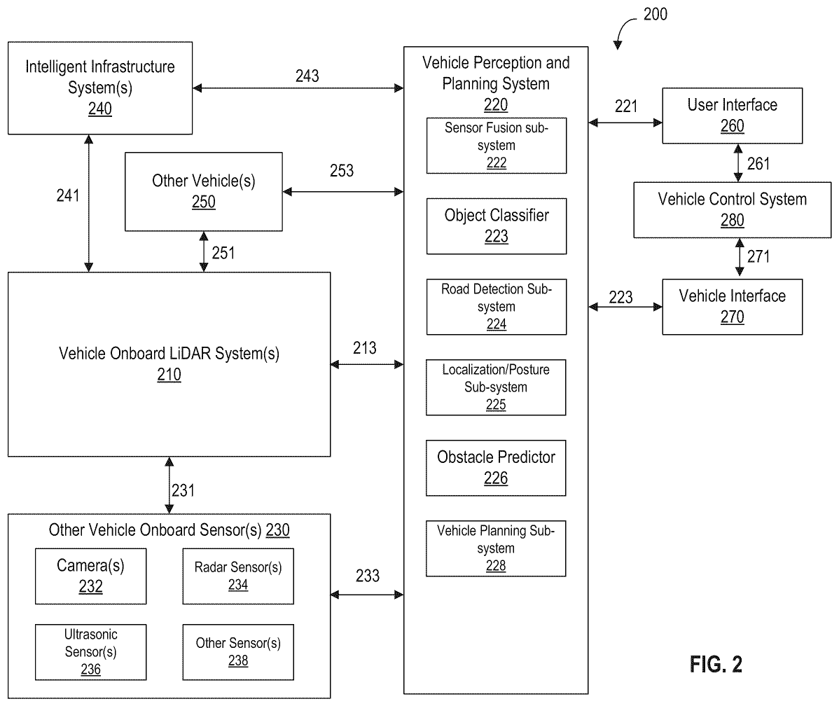

FIG. 2 is a block diagram 200 illustrating interactions between vehicle onboard LiDAR system(s) 210 and multiple other systems including a vehicle perception and planning system 220. LiDAR system(s) 210 can be mounted on or integrated to a vehicle. LiDAR system(s) 210 include sensor(s) that scan laser light to the surrounding environment to measure the distance, angle, and/or velocity of objects. Based on the scattered light that returned to LiDAR system(s) 210, it can generate sensor data (e.g., image data or 3D point cloud data) representing the perceived external environment.

LiDAR system(s) 210 can include one or more of short-range LiDAR sensors, medium-range LiDAR sensors, and long-range LiDAR sensors. A short-range LiDAR sensor measures objects located up to about 20-40 meters from the LiDAR sensor. Short-range LiDAR sensors can be used for, e.g., monitoring nearby moving objects (e.g., pedestrians crossing street in a school zone), parking assistance applications, or the like. A medium-range LiDAR sensor measures objects located up to about 100-150 meters from the LiDAR sensor. Medium-range LiDAR sensors can be used for, e.g., monitoring road intersections, assistance for merging onto or leaving a freeway, or the like. A long-range LiDAR sensor measures objects located up to about 150-300 meters. Long-range LiDAR sensors are typically used when a vehicle is travelling at high speed (e.g., on a freeway), such that the vehicle's control systems may only have a few seconds (e.g., 6-8 seconds) to respond to any situations detected by the LiDAR sensor. As shown in FIG. 2, in one embodiment, the LiDAR sensor data can be provided to vehicle perception and planning system 220 via a communication path 213 for further processing and controlling the vehicle operations. Communication path 213 can be any wired or wireless communication links that can transfer data.

With reference still to FIG. 2, in some embodiments, other vehicle onboard sensor(s) 230 are used to provide additional sensor data separately or together with LiDAR system(s) 210. Other vehicle onboard sensors 230 may include, for example, one or more camera(s) 232, one or more radar(s) 234, one or more ultrasonic sensor(s) 236, and/or other sensor(s) 238. Camera(s) 232 can take images and/or videos of the external environment of a vehicle. Camera(s) 232 can take, for example, high-definition (HD) videos having millions of pixels in each frame. A camera produces monochrome or color images and videos. Color information may be important in interpreting data for some situations (e.g., interpreting images of traffic lights). Color information may not be available from other sensors such as LiDAR or radar sensors. Camera(s) 232 can include one or more of narrow-focus cameras, wider-focus cameras, side-facing cameras, infrared cameras, fisheye cameras, or the like. The image and/or video data generated by camera(s) 232 can also be provided to vehicle perception and planning system 220 via communication path 233 for further processing and controlling the vehicle operations. Communication path 233 can be any wired or wireless communication links that can transfer data.

Other vehicle onboard sensor(s) 230 can also include radar sensor(s) 234. Radar sensor(s) 234 use radio waves to determine the range, angle, and velocity of objects. Radar sensor(s) 234 produce electromagnetic waves in the radio or microwave spectrum. The electromagnetic waves reflect off an object and some of the reflected waves return to the radar sensor, thereby providing information about the object's position and velocity. Radar sensor(s) 234 can include one or more of short-range radar(s), medium-range radar(s), and long-range radar(s). A short-range radar measures objects located at about 0.1-30 meters from the radar. A short-range radar is useful in detecting objects located nearby the vehicle, such as other vehicles, buildings, walls, pedestrians, bicyclists, etc. A short-range radar can be used to detect a blind spot, assist in lane changing, provide rear-end collision warning, assist in parking, provide emergency braking, or the like. A medium-range radar measures objects located at about 30-80 meters from the radar. A long-range radar measures objects located at about 80-200 meters. Medium- and/or long-range radars can be useful in, for example, traffic following, adaptive cruise control, and/or highway automatic braking. Sensor data generated by radar sensor(s) 234 can also be provided to vehicle perception and planning system 220 via communication path 233 for further processing and controlling the vehicle operations.

Other vehicle onboard sensor(s) 230 can also include ultrasonic sensor(s) 236. Ultrasonic sensor(s) 236 use acoustic waves or pulses to measure object located external to a vehicle. The acoustic waves generated by ultrasonic sensor(s) 236 are transmitted to the surrounding environment. At least some of the transmitted waves are reflected off an object and return to the ultrasonic sensor(s) 236. Based on the return signals, a distance of the object can be calculated. Ultrasonic sensor(s) 236 can be useful in, for example, check blind spot, identify parking spots, provide lane changing assistance into traffic, or the like. Sensor data generated by ultrasonic sensor(s) 236 can also be provided to vehicle perception and planning system 220 via communication path 233 for further processing and controlling the vehicle operations.

In some embodiments, one or more other sensor(s) 238 may be attached in a vehicle and may also generate sensor data. Other sensor(s) 238 may include, for example, global positioning systems (GPS), inertial measurement units (IMU), or the like. Sensor data generated by other sensor(s) 238 can also be provided to vehicle perception and planning system 220 via communication path 233 for further processing and controlling the vehicle operations. It is understood that communication path 233 may include one or more communication links to transfer data between the various sensor(s) 230 and vehicle perception and planning system 220.

In some embodiments, as shown in FIG. 2, sensor data from other vehicle onboard sensor(s) 230 can be provided to vehicle onboard LiDAR system(s) 210 via communication path 231. LiDAR system(s) 210 may process the sensor data from other vehicle onboard sensor(s) 230. For example, sensor data from camera(s) 232, radar sensor(s) 234, ultrasonic sensor(s) 236, and/or other sensor(s) 238 may be correlated or fused with sensor data LiDAR system(s) 210, thereby at least partially offloading the sensor fusion process performed by vehicle perception and planning system 220. It is understood that other configurations may also be implemented for transmitting and processing sensor data from the various sensors (e.g., data can be transmitted to a cloud service for processing and then the processing results can be transmitted back to the vehicle perception and planning system 220).

With reference still to FIG. 2, in some embodiments, sensors onboard other vehicle(s) 250 are used to provide additional sensor data separately or together with LiDAR system(s) 210. For example, two or more nearby vehicles may have their own respective LiDAR sensor(s), camera(s), radar sensor(s), ultrasonic sensor(s), etc. Nearby vehicles can communicate and share sensor data with one another. Communications between vehicles are also referred to as V2V (vehicle to vehicle) communications. For example, as shown in FIG. 2, sensor data generated by other vehicle(s) 250 can be communicated to vehicle perception and planning system 220 and/or vehicle onboard LiDAR system(s) 210, via communication path 253 and/or communication path 251, respectively. Communication paths 253 and 251 can be any wired or wireless communication links that can transfer data.

Sharing sensor data facilitates a better perception of the environment external to the vehicles. For instance, a first vehicle may not sense a pedestrian that is a behind a second vehicle but is approaching the first vehicle. The second vehicle may share the sensor data related to this pedestrian with the first vehicle such that the first vehicle can have additional reaction time to avoid collision with the pedestrian. In some embodiments, similar to data generated by sensor(s) 230, data generated by sensors onboard other vehicle(s) 250 may be correlated or fused with sensor data generated by LiDAR system(s) 210, thereby at least partially offloading the sensor fusion process performed by vehicle perception and planning system 220.

In some embodiments, intelligent infrastructure system(s) 240 are used to provide sensor data separately or together with LiDAR system(s) 210. Certain infrastructures may be configured to communicate with a vehicle to convey information and vice versa.

Communications between a vehicle and infrastructures are generally referred to as V2I (vehicle to infrastructure) communications. For example, intelligent infrastructure system(s) 240 may include an intelligent traffic light that can convey its status to an approaching vehicle in a message such as “changing to yellow in 5 seconds.” Intelligent infrastructure system(s) 240 may also include its own LiDAR system mounted near an intersection such that it can convey traffic monitoring information to a vehicle. For example, a left-turning vehicle at an intersection may not have sufficient sensing capabilities because some of its own sensors may be blocked by traffics in the opposite direction. In such a situation, sensors of intelligent infrastructure system(s) 240 can provide useful, and sometimes vital, data to the left-turning vehicle. Such data may include, for example, traffic conditions, information of objects in the direction the vehicle is turning to, traffic light status and predictions, or the like. These sensor data generated by intelligent infrastructure system(s) 240 can be provided to vehicle perception and planning system 220 and/or vehicle onboard LiDAR system(s) 210, via communication paths 243 and/or 241, respectively. Communication paths 243 and/or 241 can include any wired or wireless communication links that can transfer data. For example, sensor data from intelligent infrastructure system(s) 240 may be transmitted to LiDAR system(s) 210 and correlated or fused with sensor data generated by LiDAR system(s) 210, thereby at least partially offloading the sensor fusion process performed by vehicle perception and planning system 220. V2V and V2I communications described above are examples of vehicle-to-X (V2X) communications, where the “X” represents any other devices, systems, sensors, infrastructure, or the like that can share data with a vehicle.

With reference still to FIG. 2, via various communication paths, vehicle perception and planning system 220 receives sensor data from one or more of LiDAR system(s) 210, other vehicle onboard sensor(s) 230, other vehicle(s) 250, and/or intelligent infrastructure system(s) 240. In some embodiments, different types of sensor data are correlated and/or integrated by a sensor fusion sub-system 222. For example, sensor fusion sub-system 222 can generate a 360-degree model using multiple images or videos captured by multiple cameras disposed at different positions of the vehicle. Sensor fusion sub-system 222 obtains sensor data from different types of sensors and uses the combined data to perceive the environment more accurately. For example, a vehicle onboard camera 232 may not capture a clear image because it is facing the sun or a light source (e.g., another vehicle's headlight during nighttime) directly. A LiDAR system 210 may not be affected as much and therefore sensor fusion sub-system 222 can combine sensor data provided by both camera 232 and LiDAR system 210, and use the sensor data provided by LiDAR system 210 to compensate the unclear image captured by camera 232. As another example, in a rainy or foggy weather, a radar sensor 234 may work better than a camera 232 or a LiDAR system 210. Accordingly, sensor fusion sub-system 222 may use sensor data provided by the radar sensor 234 to compensate the sensor data provided by camera 232 or LiDAR system 210.

In other examples, sensor data generated by other vehicle onboard sensor(s) 230 may have a lower resolution (e.g., radar sensor data) and thus may need to be correlated and confirmed by LiDAR system(s) 210, which usually has a higher resolution. For example, a sewage cover (also referred to as a manhole cover) may be detected by radar sensor 234 as an object towards which a vehicle is approaching. Due to the low-resolution nature of radar sensor 234, vehicle perception and planning system 220 may not be able to determine whether the object is an obstacle that the vehicle needs to avoid. High-resolution sensor data generated by LiDAR system(s) 210 thus can be used to correlated and confirm that the object is a sewage cover and causes no harm to the vehicle.

Vehicle perception and planning system 220 further comprises an object classifier 223. Using raw sensor data and/or correlated/fused data provided by sensor fusion sub-system 222, object classifier 223 can detect and classify the objects and estimate the positions of the objects. In some embodiments, object classifier 233 can use machine-learning based techniques to detect and classify objects. Examples of the machine-learning based techniques include utilizing algorithms such as region-based convolutional neural networks (R-CNN), Fast R-CNN, Faster R-CNN, histogram of oriented gradients (HOG), region-based fully convolutional network (R-FCN), single shot detector (SSD), spatial pyramid pooling (SPP-net), and/or You Only Look Once (Yolo).

Vehicle perception and planning system 220 further comprises a road detection sub-system 224. Road detection sub-system 224 localizes the road and identifies objects and/or markings on the road. For example, based on raw or fused sensor data provided by radar sensor(s) 234, camera(s) 232, and/or LiDAR system(s) 210, road detection sub-system 224 can build a 3D model of the road based on machine-learning techniques (e.g., pattern recognition algorithms for identifying lanes). Using the 3D model of the road, road detection sub-system 224 can identify objects (e.g., obstacles or debris on the road) and/or markings on the road (e.g., lane lines, turning marks, crosswalk marks, or the like).

Vehicle perception and planning system 220 further comprises a localization and vehicle posture sub-system 225. Based on raw or fused sensor data, localization and vehicle posture sub-system 225 can determine position of the vehicle and the vehicle's posture. For example, using sensor data from LiDAR system(s) 210, camera(s) 232, and/or GPS data, localization and vehicle posture sub-system 225 can determine an accurate position of the vehicle on the road and the vehicle's six degrees of freedom (e.g., whether the vehicle is moving forward or backward, up or down, and left or right). In some embodiments, high-definition (HD) maps are used for vehicle localization. HD maps can provide highly detailed, three-dimensional, computerized maps that pinpoint a vehicle's location. For instance, using the HD maps, localization and vehicle posture sub-system 225 can determine precisely the vehicle's current position (e.g., which lane of the road the vehicle is currently in, how close it is to a curb or a sidewalk) and predict vehicle's future positions.

Vehicle perception and planning system 220 further comprises obstacle predictor 226. Objects identified by object classifier 223 can be stationary (e.g., a light pole, a road sign) or dynamic (e.g., a moving pedestrian, bicycle, another car). For moving objects, predicting their moving path or future positions can be important to avoid collision. Obstacle predictor 226 can predict an obstacle trajectory and/or warn the driver or the vehicle planning sub-system 228 about a potential collision. For example, if there is a high likelihood that the obstacle's trajectory intersects with the vehicle's current moving path, obstacle predictor 226 can generate such a warning. Obstacle predictor 226 can use a variety of techniques for making such a prediction. Such techniques include, for example, constant velocity or acceleration models, constant turn rate and velocity/acceleration models, Kalman Filter and Extended Kalman Filter based models, recurrent neural network (RNN) based models, long short-term memory (LSTM) neural network-based models, encoder-decoder RNN models, or the like.

With reference still to FIG. 2, in some embodiments, vehicle perception and planning system 220 further comprises vehicle planning sub-system 228. Vehicle planning sub-system 228 can include a route planner, a driving behaviors planner, and a motion planner. The route planner can plan the route of a vehicle based on the vehicle's current location data, target location data, traffic information, etc. The driving behavior planner adjusts the timing and planned movement based on how other objects might move, using the obstacle prediction results provided by obstacle predictor 226. The motion planner determines the specific operations the vehicle needs to follow. The planning results are then communicated to vehicle control system 280 via vehicle interface 270. The communication can be performed through communication paths 223 and 271, which include any wired or wireless communication links that can transfer data.

Vehicle control system 280 controls the vehicle's steering mechanism, throttle, brake, etc., to operate the vehicle according to the planned route and movement. Vehicle perception and planning system 220 may further comprise a user interface 260, which provides a user (e.g., a driver) access to vehicle control system 280 to, for example, override or take over control of the vehicle when necessary. User interface 260 can communicate with vehicle perception and planning system 220, for example, to obtain and display raw or fused sensor data, identified objects, vehicle's location/posture, etc. These displayed data can help a user to better operate the vehicle. User interface 260 can communicate with vehicle perception and planning system 220 and/or vehicle control system 280 via communication paths 221 and 261 respectively, which include any wired or wireless communication links that can transfer data. It is understood that the various systems, sensors, communication links, and interfaces in FIG. 2 can be configured in any desired manner and not limited to the configuration shown in FIG. 2.

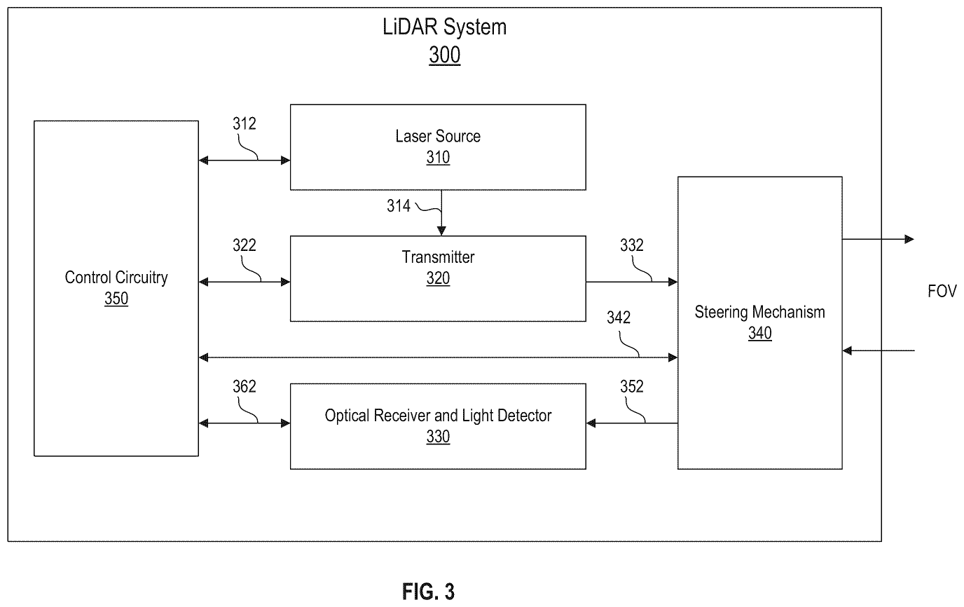

FIG. 3 is a block diagram illustrating an exemplary LiDAR system 300. LiDAR system 300 can be used to implement LiDAR system 110, 120A-F, and/or 210 shown in FIGS. 1 and 2. In one embodiment, LiDAR system 300 comprises a laser source 310, a transmitter 320, an optical receiver and light detector 330, a steering system 340, and a control circuitry 350. These components are coupled together using communications paths 312, 314, 322, 332, 343, 352, and 362. These communications paths include communication links (wired or wireless, bidirectional or unidirectional) among the various LiDAR system components but need not be physical components themselves. While the communications paths can be implemented by one or more electrical wires, buses, or optical fibers, the communication paths can also be wireless channels or free-space optical paths so that no physical communication medium is present. For example, in one embodiment of LiDAR system 300, communication path 314 between laser source 310 and transmitter 320 may be implemented using one or more optical fibers. Communication paths 332 and 352 may represent optical paths implemented using free space optical components and/or optical fibers. And communication paths 312, 322, 342, and 362 may be implemented using one or more electrical wires that carry electrical signals. The communications paths can also include one or more of the above types of communication mediums (e.g., they can include an optical fiber and a free-space optical component, or include one or more optical fibers and one or more electrical wires).

LiDAR system 300 can also include other components not depicted in FIG. 3, such as power buses, power supplies, LED indicators, switches, etc. Additionally, other communication connections among components may be present, such as a direct connection between light source 310 and optical receiver and light detector 330 to provide a reference signal so that the time from when a light pulse is transmitted until a return light pulse is detected can be accurately measured.

Laser source 310 outputs laser light for illuminating objects in a field of view (FOV). Laser source 310 can be, for example, a semiconductor-based laser (e.g., a diode laser) and/or a fiber-based laser. A semiconductor-based laser can be, for example, an edge emitting laser (EEL), a vertical cavity surface emitting laser (VCSEL), or the like. A fiber-based laser is a laser in which the active gain medium is an optical fiber doped with rare-earth elements such as erbium, ytterbium, neodymium, dysprosium, praseodymium, thulium and/or holmium. In some embodiments, a fiber laser is based on double-clad fibers, in which the gain medium forms the core of the fiber surrounded by two layers of cladding. The double-clad fiber allows the core to be pumped with a high-power beam, thereby enabling the laser source to be a high-power fiber laser source.

In some embodiments, laser source 310 comprises a master oscillator (also referred to as a seed laser) and power amplifier (MOPA). The power amplifier amplifies the output power of the seed laser. The power amplifier can be a fiber amplifier, a bulk amplifier, or a semiconductor optical amplifier. The seed laser can be a diode laser (e.g., a Fabry-Perot cavity laser, a distributed feedback laser), a solid-state bulk laser, or a tunable external-cavity diode laser. In some embodiments, laser source 310 can be an optically pumped microchip laser. Microchip lasers are alignment-free monolithic solid-state lasers where the laser crystal is directly contacted with the end mirrors of the laser resonator. A microchip laser is typically pumped with a laser diode (directly or using a fiber) to obtain the desired output power. A microchip laser can be based on neodymium-doped yttrium aluminum garnet (Y₃Al₅O₁₂) laser crystals (i.e., Nd:YAG), or neodymium-doped vanadate (i.e., ND:YVO₄) laser crystals.

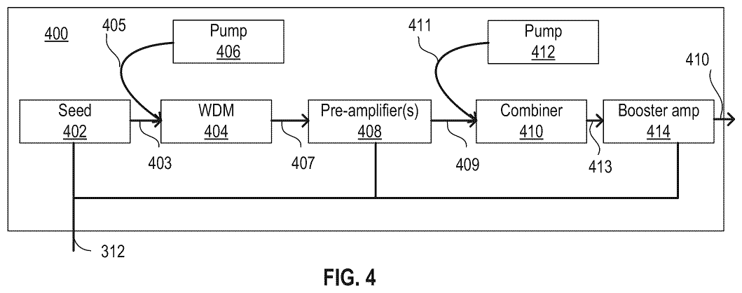

FIG. 4 is a block diagram illustrating an exemplary fiber-based laser source 400 having a seed laser and one or more pumps (e.g., laser diodes) for pumping desired output power. Fiber-based laser source 400 is an example of laser source 310 depicted in FIG. 3. In some embodiments, fiber-based laser source 400 comprises a seed laser 402 to generate initial light pulses of one or more wavelengths (e.g., 1550 nm), which are provided to a wavelength-division multiplexor (WDM) 404 via an optical fiber 403. Fiber-based laser source 400 further comprises a pump 406 for providing laser power (e.g., of a different wavelength, such as 980 nm) to WDM 404 via an optical fiber 405. WDM 404 multiplexes the light pulses provided by seed laser 402 and the laser power provided by pump 406 onto a single optical fiber 407. The output of WDM 404 can then be provided to one or more pre-amplifier(s) 408 via optical fiber 407. Pre-amplifier(s) 408 can be optical amplifier(s) that amplify optical signals (e.g., with about 20-30 dB gain). In some embodiments, pre-amplifier(s) 408 are low noise amplifiers. Pre-amplifier(s) 408 output to a combiner 410 via an optical fiber 409. Combiner 410 combines the output laser light of pre-amplifier(s) 408 with the laser power provided by pump 412 via an optical fiber 411. Combiner 410 can combine optical signals having the same wavelength or different wavelengths. One example of a combiner is a WDM. Combiner 410 provides pulses to a booster amplifier 414, which produces output light pulses via optical fiber 410. The booster amplifier 414 provides further amplification of the optical signals. The outputted light pulses can then be transmitted to transmitter 320 and/or steering mechanism 340 (shown in FIG. 3). It is understood that FIG. 4 illustrates one exemplary configuration of fiber-based laser source 400. Laser source 400 can have many other configurations using different combinations of one or more components shown in FIG. 4 and/or other components not shown in FIG. 4 (e.g., other components such as power supplies, lens, filters, splitters, combiners, etc.).

In some variations, fiber-based laser source 400 can be controlled (e.g., by control circuitry 350) to produce pulses of different amplitudes based on the fiber gain profile of the fiber used in fiber-based laser source 400. Communication path 312 couples fiber-based laser source 400 to control circuitry 350 (shown in FIG. 3) so that components of fiber-based laser source 400 can be controlled by or otherwise communicate with control circuitry 350. Alternatively, fiber-based laser source 400 may include its own dedicated controller. Instead of control circuitry 350 communicating directly with components of fiber-based laser source 400, a dedicated controller of fiber-based laser source 400 communicates with control circuitry 350 and controls and/or communicates with the components of fiber-based light source 400. Fiber-based light source 400 can also include other components not shown, such as one or more power connectors, power supplies, and/or power lines.

Referencing FIG. 3, typical operating wavelengths of laser source 310 comprise, for example, about 850 nm, about 905 nm, about 940 nm, about 1064 nm, and about 1550 nm. The upper limit of maximum usable laser power is set by the U.S. FDA (U.S. Food and Drug Administration) regulations. The optical power limit at 1550 nm wavelength is much higher than those of the other aforementioned wavelengths. Further, at 1550 nm, the optical power loss in a fiber is low. There characteristics of the 1550 nm wavelength make it more beneficial for long-range LiDAR applications. The amount of optical power output from laser source 310 can be characterized by its peak power, average power, and the pulse energy. The peak power is the ratio of pulse energy to the width of the pulse (e.g., full width at half maximum or FWHM). Thus, a smaller pulse width can provide a larger peak power for a fixed amount of pulse energy. A pulse width can be in the range of nanosecond or picosecond. The average power is the product of the energy of the pulse and the pulse repetition rate (PRR). As described in more detail below, the PRR represents the frequency of the pulsed laser light. The PRR typically corresponds to the maximum range that a LiDAR system can measure. Laser source 310 can be configured to produce pulses at high PRR to meet the desired number of data points in a point cloud generated by the LiDAR system. Laser source 310 can also be configured to produce pulses at medium or low PRR to meet the desired maximum detection distance. Wall plug efficiency (WPE) is another factor to evaluate the total power consumption, which may be a key indicator in evaluating the laser efficiency. For example, as shown in FIG. 1, multiple LiDAR systems may be attached to a vehicle, which may be an electrical-powered vehicle or a vehicle otherwise having limited fuel or battery power supply. Therefore, high WPE and intelligent ways to use laser power are often among the important considerations when selecting and configuring laser source 310 and/or designing laser delivery systems for vehicle-mounted LiDAR applications.

It is understood that the above descriptions provide non-limiting examples of a laser source 310. Laser source 310 can be configured to include many other types of light sources (e.g., laser diodes, short-cavity fiber lasers, solid-state lasers, and/or tunable external cavity diode lasers) that are configured to generate one or more light signals at various wavelengths. In some examples, light source 310 comprises amplifiers (e.g., pre-amplifiers and/or booster amplifiers), which can be a doped optical fiber amplifier, a solid-state bulk amplifier, and/or a semiconductor optical amplifier. The amplifiers are configured to receive and amplify light signals with desired gains.

With reference back to FIG. 3, LiDAR system 300 further comprises a transmitter 320. Laser source 310 provides laser light (e.g., in the form of a laser beam) to transmitter 320. The laser light provided by laser source 310 can be amplified laser light with a predetermined or controlled wavelength, pulse repetition rate, and/or power level. Transmitter 320 receives the laser light from laser source 310 and transmits the laser light to steering mechanism 340 with low divergence. In some embodiments, transmitter 320 can include, for example, optical components (e.g., lens, fibers, mirrors, etc.) for transmitting laser beams to a field-of-view (FOV) directly or via steering mechanism 340. While FIG. 3 illustrates transmitter 320 and steering mechanism 340 as separate components, they may be combined or integrated as one system in some embodiments. Steering mechanism 340 is described in more detail below.

Laser beams provided by laser source 310 may diverge as they travel to transmitter 320. Therefore, transmitter 320 often comprises a collimating lens configured to collect the diverging laser beams and produce more parallel optical beams with reduced or minimum divergence. The collimated optical beams can then be further directed through various optics such as mirrors and lens. A collimating lens may be, for example, a single plano-convex lens or a lens group. The collimating lens can be configured to achieve any desired properties such as the beam diameter, divergence, numerical aperture, focal length, or the like. A beam propagation ratio or beam quality factor (also referred to as the M² factor) is used for measurement of laser beam quality. In many LiDAR applications, it is important to have good laser beam quality in the generated transmitting laser beam. The M² factor represents a degree of variation of a beam from an ideal Gaussian beam. Thus, the M² factor reflects how well a collimated laser beam can be focused on a small spot, or how well a divergent laser beam can be collimated. Therefore, laser source 310 and/or transmitter 320 can be configured to meet, for example, a scan resolution requirement while maintaining the desired M² factor.

One or more of the light beams provided by transmitter 320 are scanned by steering mechanism 340 to a FOV. Steering mechanism 340 scans light beams in multiple dimensions (e.g., in both the horizontal and vertical dimension) to facilitate LiDAR system 300 to map the environment by generating a 3D point cloud. Steering mechanism 340 will be described in more detail below. The laser light scanned to an FOV may be scattered or reflected by an object in the FOV. At least a portion of the scattered or reflected light returns to LiDAR system 300. FIG. 3 further illustrates an optical receiver and light detector 330 configured to receive the return light. Optical receiver and light detector 330 comprises an optical receiver that is configured to collect the return light from the FOV. The optical receiver can include optics (e.g., lens, fibers, mirrors, etc.) for receiving, redirecting, focus, amplifying, and/or filtering return light from the FOV. For example, the optical receiver often includes a collection lens (e.g., a single plano-convex lens or a lens group) to collect and/or focus the collected return light onto a light detector.

A light detector detects the return light focused by the optical receiver and generates current and/or voltage signals proportional to the incident intensity of the return light. Based on such current and/or voltage signals, the depth information of the object in the FOV can be derived. One exemplary method for deriving such depth information is based on the direct TOF (time of flight), which is described in more detail below. A light detector may be characterized by its detection sensitivity, quantum efficiency, detector bandwidth, linearity, signal to noise ratio (SNR), overload resistance, interference immunity, etc. Based on the applications, the light detector can be configured or customized to have any desired characteristics. For example, optical receiver and light detector 330 can be configured such that the light detector has a large dynamic range while having a good linearity. The light detector linearity indicates the detector's capability of maintaining linear relationship between input optical signal power and the detector's output. A detector having good linearity can maintain a linear relationship over a large dynamic input optical signal range.

To achieve desired detector characteristics, configurations or customizations can be made to the light detector's structure and/or the detector's material system. Various detector structure can be used for a light detector. For example, a light detector structure can be a PIN based structure, which has a undoped intrinsic semiconductor region (i.e., an “i” region) between a p-type semiconductor and an n-type semiconductor region. Other light detector structures comprise, for example, an avalanche photodiode (APD) based structure, a photomultiplier tube (PMT) based structure, a silicon photomultiplier (SiPM) based structure, a single-photon avalanche diode (SPAD) based structure, and/or quantum wires. For material systems used in a light detector, Si, InGaAs, and/or Si/Ge based materials can be used. It is understood that many other detector structures and/or material systems can be used in optical receiver and light detector 330.

A light detector (e.g., an APD based detector) may have an internal gain such that the input signal is amplified when generating an output signal. However, noise may also be amplified due to the light detector's internal gain. Common types of noise include signal shot noise, dark current shot noise, thermal noise, and amplifier noise (TIA). In some embodiments, optical receiver and light detector 330 may include a pre-amplifier that is a low noise amplifier (LNA). In some embodiments, the pre-amplifier may also include a TIA-transimpedance amplifier, which converts a current signal to a voltage signal. For a linear detector system, input equivalent noise or noise equivalent power (NEP) measures how sensitive the light detector is to weak signals. Therefore, they can be used as indicators of the overall system performance. For example, the NEP of a light detector specifies the power of the weakest signal that can be detected and therefore it in turn specifies the maximum range of a LiDAR system. It is understood that various light detector optimization techniques can be used to meet the requirement of LiDAR system 300. Such optimization techniques may include selecting different detector structures, materials, and/or implement signal processing techniques (e.g., filtering, noise reduction, amplification, or the like). For example, in addition to or instead of using direct detection of return signals (e.g., by using TOF), coherent detection can also be used for a light detector. Coherent detection allows for detecting amplitude and phase information of the received light by interfering the received light with a local oscillator. Coherent detection can improve detection sensitivity and noise immunity.

FIG. 3 further illustrates that LiDAR system 300 comprises steering mechanism 340. As described above, steering mechanism 340 directs light beams from transmitter 320 to scan a FOV in multiple dimensions. A steering mechanism is referred to as a raster mechanism or a scanning mechanism. Scanning light beams in multiple directions (e.g., in both the horizontal and vertical directions) facilitates a LiDAR system to map the environment by generating an image or a 3D point cloud. A steering mechanism can be based on mechanical scanning and/or solid-state scanning. Mechanical scanning uses rotating mirrors to steer the laser beam or physically rotate the LiDAR transmitter and receiver (collectively referred to as transceiver) to scan the laser beam. Solid-state scanning directs the laser beam to various positions through the FOV without mechanically moving any macroscopic components such as the transceiver. Solid-state scanning mechanisms include, for example, optical phased arrays-based steering and flash LiDAR based steering. In some embodiments, because solid-state scanning mechanisms do not physically move macroscopic components, the steering performed by a solid-state scanning mechanism may be referred to as effective steering. A LiDAR system using solid-state scanning may also be referred to as a non-mechanical scanning or simply non-scanning LiDAR system (a flash LiDAR system is an exemplary non-scanning LiDAR system).

Steering mechanism 340 can be used with the transceiver (e.g., transmitter 320 and optical receiver and light detector 330) to scan the FOV for generating an image or a 3D point cloud. As an example, to implement steering mechanism 340, a two-dimensional mechanical scanner can be used with a single-point or several single-point transceivers. A single-point transceiver transmits a single light beam or a small number of light beams (e.g., 2-8 beams) to the steering mechanism. A two-dimensional mechanical steering mechanism comprises, for example, polygon mirror(s), oscillating mirror(s), rotating prism(s), rotating tilt mirror surface(s), or a combination thereof. In some embodiments, steering mechanism 340 may include non-mechanical steering mechanism(s) such as solid-state steering mechanism(s). For example, steering mechanism 340 can be based on tuning wavelength of the laser light combined with refraction effect, and/or based on reconfigurable grating/phase array. In some embodiments, steering mechanism 340 can use a single scanning device to achieve two-dimensional scanning or two devices combined to realize two-dimensional scanning.

As another example, to implement steering mechanism 340, a one-dimensional mechanical scanner can be used with an array or a large number of single-point transceivers. Specifically, the transceiver array can be mounted on a rotating platform to achieve 360-degree horizontal field of view. Alternatively, a static transceiver array can be combined with the one-dimensional mechanical scanner. A one-dimensional mechanical scanner comprises polygon mirror(s), oscillating mirror(s), rotating prism(s), rotating tilt mirror surface(s) for obtaining a forward-looking horizontal field of view. Steering mechanisms using mechanical scanners can provide robustness and reliability in high volume production for automotive applications.

As another example, to implement steering mechanism 340, a two-dimensional transceiver can be used to generate a scan image or a 3D point cloud directly. In some embodiments, a stitching or micro shift method can be used to improve the resolution of the scan image or the field of view being scanned. For example, using a two-dimensional transceiver, signals generated at one direction (e.g., the horizontal direction) and signals generated at the other direction (e.g., the vertical direction) may be integrated, interleaved, and/or matched to generate a higher or full resolution image or 3D point cloud representing the scanned FOV.

Some implementations of steering mechanism 340 comprise one or more optical redirection elements (e.g., mirrors or lens) that steer return light signals (e.g., by rotating, vibrating, or directing) along a receive path to direct the return light signals to optical receiver and light detector 330. The optical redirection elements that direct light signals along the transmitting and receiving paths may be the same components (e.g., shared), separate components (e.g., dedicated), and/or a combination of shared and separate components. This means that in some cases the transmitting and receiving paths are different although they may partially overlap (or in some cases, substantially overlap).

With reference still to FIG. 3, LiDAR system 300 further comprises control circuitry 350. Control circuitry 350 can be configured and/or programmed to control various parts of the LiDAR system 300 and/or to perform signal processing. In a typical system, control circuitry 350 can be configured and/or programmed to perform one or more control operations including, for example, controlling laser source 310 to obtain desired laser pulse timing, repetition rate, and power; controlling steering mechanism 340 (e.g., controlling the speed, direction, and/or other parameters) to scan the FOV and maintain pixel registration/alignment; controlling optical receiver and light detector 330 (e.g., controlling the sensitivity, noise reduction, filtering, and/or other parameters) such that it is an optimal state; and monitoring overall system health/status for functional safety.

Control circuitry 350 can also be configured and/or programmed to perform signal processing to the raw data generated by optical receiver and light detector 330 to derive distance and reflectance information, and perform data packaging and communication to vehicle perception and planning system 220 (shown in FIG. 2). For example, control circuitry 350 determines the time it takes from transmitting a light pulse until a corresponding return light pulse is received; determines when a return light pulse is not received for a transmitted light pulse; determines the direction (e.g., horizontal and/or vertical information) for a transmitted/return light pulse; determines the estimated range in a particular direction; and/or determines any other type of data relevant to LiDAR system 300.

LiDAR system 300 can be disposed in a vehicle, which may operate in many different environments including hot or cold weather, rough road conditions that may cause intense vibration, high or low humidifies, dusty areas, etc. Therefore, in some embodiments, optical and/or electronic components of LiDAR system 300 (e.g., optics in transmitter 320, optical receiver and light detector 330, and steering mechanism 340) are disposed or configured in such a manner to maintain long term mechanical and optical stability. For example, components in LiDAR system 300 may be secured and sealed such that they can operate under all conditions a vehicle may encounter. As an example, an anti-moisture coating and/or hermetic sealing may be applied to optical components of transmitter 320, optical receiver and light detector 330, and steering mechanism 340 (and other components that are susceptible to moisture). As another example, housing(s), enclosure(s), and/or window can be used in LiDAR system 300 for providing desired characteristics such as hardness, ingress protection (IP) rating, self-cleaning capability, resistance to chemical and resistance to impact, or the like. In addition, efficient and economical methodologies for assembling LiDAR system 300 may be used to meet the LiDAR operating requirements while keeping the cost low.

It is understood by a person of ordinary skill in the art that FIG. 3 and the above descriptions are for illustrative purposes only, and a LiDAR system can include other functional units, blocks, or segments, and can include variations or combinations of these above functional units, blocks, or segments. For example, LiDAR system 300 can also include other components not depicted in FIG. 3, such as power buses, power supplies, LED indicators, switches, etc. Additionally, other connections among components may be present, such as a direct connection between light source 310 and optical receiver and light detector 330 so that light detector 330 can accurately measure the time from when light source 310 transmits a light pulse until light detector 330 detects a return light pulse.

The components shown in FIG. 3 are coupled together using communications paths 312, 314, 322, 332, 342, 352, and 362. These communications paths represent communication (bidirectional or unidirectional) among the various LiDAR system components but need not be physical components themselves. While the communications paths can be implemented by one or more electrical wires, busses, or optical fibers, the communication paths can also be wireless channels or open-air optical paths so that no physical communication medium is present. For example, in one exemplary LiDAR system, communication path 314 includes one or more optical fibers; communication path 352 represents an optical path; and communication paths 312, 322, 342, and 362 are all electrical wires that carry electrical signals. The communication paths can also include more than one of the above types of communication mediums (e.g., they can include an optical fiber and an optical path, or one or more optical fibers and one or more electrical wires).

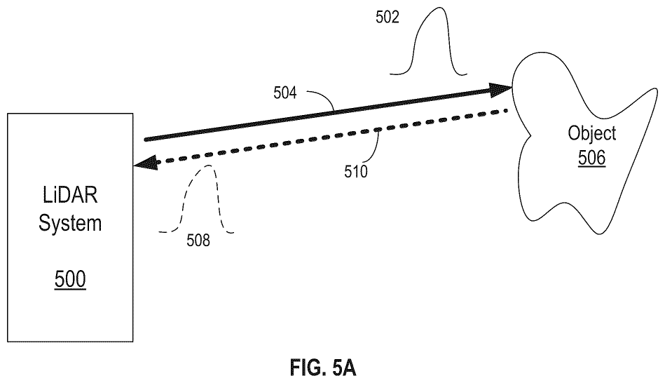

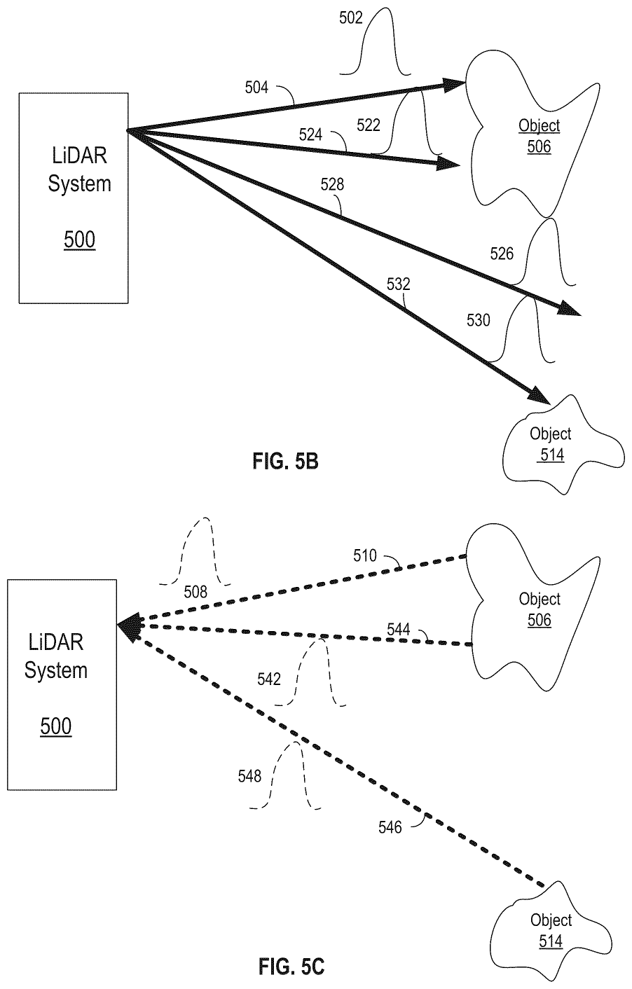

As described above, some LiDAR systems use the time-of-flight (TOF) of light signals (e.g., light pulses) to determine the distance to objects in a light path. For example, with reference to FIG. 5A, an exemplary LiDAR system 500 includes a laser light source (e.g., a fiber laser), a steering system (e.g., a system of one or more moving mirrors), and a light detector (e.g., a photon detector with one or more optics). LiDAR system 500 can be implemented using, for example, LiDAR system 300 described above. LiDAR system 500 transmits a light pulse 502 along light path 504 as determined by the steering system of LiDAR system 500. In the depicted example, light pulse 502, which is generated by the laser light source, is a short pulse of laser light. Further, the signal steering system of the LiDAR system 500 is a pulsed-signal steering system. However, it should be appreciated that LiDAR systems can operate by generating, transmitting, and detecting light signals that are not pulsed and derive ranges to an object in the surrounding environment using techniques other than time-of-flight. For example, some LiDAR systems use frequency modulated continuous waves (i.e., “FMCW”). It should be further appreciated that any of the techniques described herein with respect to time-of-flight based systems that use pulsed signals also may be applicable to LiDAR systems that do not use one or both of these techniques.

Referring back to FIG. 5A (e.g., illustrating a time-of-flight LiDAR system that uses light pulses), when light pulse 502 reaches object 506, light pulse 502 scatters or reflects to generate a return light pulse 508. Return light pulse 508 may return to system 500 along light path 510. The time from when transmitted light pulse 502 leaves LiDAR system 500 to when return light pulse 508 arrives back at LiDAR system 500 can be measured (e.g., by a processor or other electronics, such as control circuitry 350, within the LiDAR system). This time-of-flight combined with the knowledge of the speed of light can be used to determine the range/distance from LiDAR system 500 to the portion of object 506 where light pulse 502 scattered or reflected.

By directing many light pulses, as depicted in FIG. 5B, LiDAR system 500 scans the external environment (e.g., by directing light pulses 502, 522, 526, 530 along light paths 504, 524, 528, 532, respectively). As depicted in FIG. 5C, LiDAR system 500 receives return light pulses 508, 542, 548 (which correspond to transmitted light pulses 502, 522, 530, respectively). Return light pulses 508, 542, and 548 are generated by scattering or reflecting the transmitted light pulses by one of objects 506 and 514. Return light pulses 508, 542, and 548 may return to LiDAR system 500 along light paths 510, 544, and 546, respectively. Based on the direction of the transmitted light pulses (as determined by LiDAR system 500) as well as the calculated range from LiDAR system 500 to the portion of objects that scatter or reflect the light pulses (e.g., the portions of objects 506 and 514), the external environment within the detectable range (e.g., the field of view between path 504 and 532, inclusively) can be precisely mapped or plotted (e.g., by generating a 3D point cloud or images).

If a corresponding light pulse is not received for a particular transmitted light pulse, then it may be determined that there are no objects within a detectable range of LiDAR system 500 (e.g., an object is beyond the maximum scanning distance of LiDAR system 500). For example, in FIG. 5B, light pulse 526 may not have a corresponding return light pulse (as illustrated in FIG. 5C) because light pulse 526 may not produce a scattering event along its transmission path 528 within the predetermined detection range. LiDAR system 500, or an external system in communication with LiDAR system 500 (e.g., a cloud system or service), can interpret the lack of return light pulse as no object being disposed along light path 528 within the detectable range of LiDAR system 500.

In FIG. 5B, light pulses 502, 522, 526, and 530 can be transmitted in any order, serially, in parallel, or based on other timings with respect to each other. Additionally, while FIG. 5B depicts transmitted light pulses as being directed in one dimension or one plane (e.g., the plane of the paper), LiDAR system 500 can also direct transmitted light pulses along other dimension(s) or plane(s). For example, LiDAR system 500 can also direct transmitted light pulses in a dimension or plane that is perpendicular to the dimension or plane shown in FIG. 5B, thereby forming a 2-dimensional transmission of the light pulses. This 2-dimensional transmission of the light pulses can be point-by-point, line-by-line, all at once, or in some other manner. A point cloud or image from a 1-dimensional transmission of light pulses (e.g., a single horizontal line) can generate 2-dimensional data (e.g., (1) data from the horizontal transmission direction and (2) the range or distance to objects). Similarly, a point cloud or image from a 2-dimensional transmission of light pulses can generate 3-dimensional data (e.g., (1) data from the horizontal transmission direction, (2) data from the vertical transmission direction, and (3) the range or distance to objects). In general, a LiDAR system performing an n-dimensional transmission of light pulses generates (n+1) dimensional data. This is because the LiDAR system can measure the depth of an object or the range/distance to the object, which provides the extra dimension of data. Therefore, a 2D scanning by a LiDAR system can generate a 3D point cloud for mapping the external environment of the LiDAR system.

The density of a point cloud refers to the number of measurements (data points) per area performed by the LiDAR system. A point cloud density relates to the LiDAR scanning resolution. Typically, a larger point cloud density, and therefore a higher resolution, is desired at least for the region of interest (ROI). The density of points in a point cloud or image generated by a LiDAR system is equal to the number of pulses divided by the field of view. In some embodiments, the field of view can be fixed. Therefore, to increase the density of points generated by one set of transmission-receiving optics (or transceiver optics), the LiDAR system may need to generate a pulse more frequently. In other words, a light source with a higher pulse repetition rate (PRR) is needed. On the other hand, by generating and transmitting pulses more frequently, the farthest distance that the LiDAR system can detect may be limited. For example, if a return signal from a distant object is received after the system transmits the next pulse, the return signals may be detected in a different order than the order in which the corresponding signals are transmitted, thereby causing ambiguity if the system cannot correctly correlate the return signals with the transmitted signals.

To illustrate, consider an exemplary LiDAR system that can transmit laser pulses with a repetition rate between 500 kHz and 1 MHz. Based on the time it takes for a pulse to return to the LiDAR system and to avoid mix-up of return pulses from consecutive pulses in a conventional LiDAR design, the farthest distance the LiDAR system can detect may be 300 meters and 150 meters for 500 kHz and 1 MHz, respectively. The density of points of a LiDAR system with 500 kHz repetition rate is half of that with 1 MHz. Thus, this example demonstrates that, if the system cannot correctly correlate return signals that arrive out of order, increasing the repetition rate from 500 kHz to 1 MHz (and thus improving the density of points of the system) may reduce the detection range of the system. Various techniques are used to mitigate the tradeoff between higher PRR and limited detection range. For example, multiple wavelengths can be used for detecting objects in different ranges. Optical and/or signal processing techniques are also used to correlate between transmitted and return light signals.

Various systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Various systems, apparatus, and methods described herein may be implemented using computers operating in a client-server relationship. Typically, in such a system, the client computers are located remotely from the server computers and interact via a network. The client-server relationship may be defined and controlled by computer programs running on the respective client and server computers. Examples of client computers can include desktop computers, workstations, portable computers, cellular smartphones, tablets, or other types of computing devices.

Various systems, apparatus, and methods described herein may be implemented using a computer program product tangibly embodied in an information carrier, e.g., in a non-transitory machine-readable storage device, for execution by a programmable processor; and the method processes and steps described herein, including one or more of the steps of FIGS. 1-5B and FIGS. 7-10 below, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

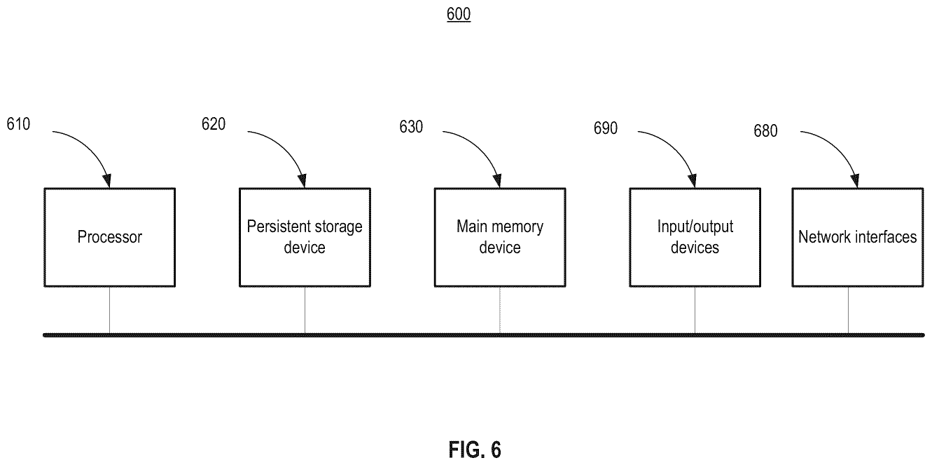

A high-level block diagram of an exemplary apparatus that may be used to implement systems, apparatus and methods described herein is illustrated in FIG. 6. Apparatus 600 comprises a processor 610 operatively coupled to a persistent storage device 620 and a main memory device 630. Processor 610 controls the overall operation of apparatus 600 by executing computer program instructions that define such operations. The computer program instructions may be stored in persistent storage device 620, or other computer-readable medium, and loaded into main memory device 630 when execution of the computer program instructions is desired. For example, processor 610 may be used to implement one or more components and systems described herein, such as control circuitry 350 (shown in FIG. 3), vehicle perception and planning system 220 (shown in FIG. 2), and vehicle control system 280 (shown in FIG. 2). Thus, the method steps of some of FIGS. 1-5B and FIGS. 7-10 below can be defined by the computer program instructions stored in main memory device 630 and/or persistent storage device 620 and controlled by processor 610 executing the computer program instructions. For example, the computer program instructions can be implemented as computer executable code programmed by one skilled in the art to perform an algorithm defined by the method steps of some of FIGS. 1-8. Accordingly, by executing the computer program instructions, the processor 610 executes an algorithm defined by the methods of some of FIGS. 1-5B and FIGS. 7-10 below. Apparatus 600 also includes one or more network interfaces 680 for communicating with other devices via a network. Apparatus 600 may also include one or more input/output devices 690 that enable user interaction with apparatus 600 (e.g., display, keyboard, mouse, speakers, buttons, etc.).

Processor 610 may include both general and special purpose microprocessors and may be the sole processor or one of multiple processors of apparatus 600. Processor 610 may comprise one or more central processing units (CPUs), and one or more graphics processing units (GPUs), which, for example, may work separately from and/or multi-task with one or more CPUs to accelerate processing, e.g., for various image processing applications described herein. Processor 610, persistent storage device 620, and/or main memory device 630 may include, be supplemented by, or incorporated in, one or more application-specific integrated circuits (ASICs) and/or one or more field programmable gate arrays (FPGAs).

Persistent storage device 620 and main memory device 630 each comprise a tangible non-transitory computer readable storage medium. Persistent storage device 620, and main memory device 630, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 690 may include peripherals, such as a printer, scanner, display screen, etc. For example, input/output devices 690 may include a display device such as a cathode ray tube (CRT), plasma or liquid crystal display (LCD) monitor for displaying information to a user, a keyboard, and a pointing device such as a mouse or a trackball by which the user can provide input to apparatus 600.

Any or all of the functions of the systems and apparatuses discussed herein may be performed by processor 610, and/or incorporated in, an apparatus or a system such as LiDAR system 300. Further, LiDAR system 300 and/or apparatus 600 may utilize one or more neural networks or other deep-learning techniques performed by processor 610 or other systems or apparatuses discussed herein.

One skilled in the art will recognize that an implementation of an actual computer or computer system may have other structures and may contain other components as well, and that FIG. 6 is a high-level representation of some of the components of such a computer for illustrative purposes.

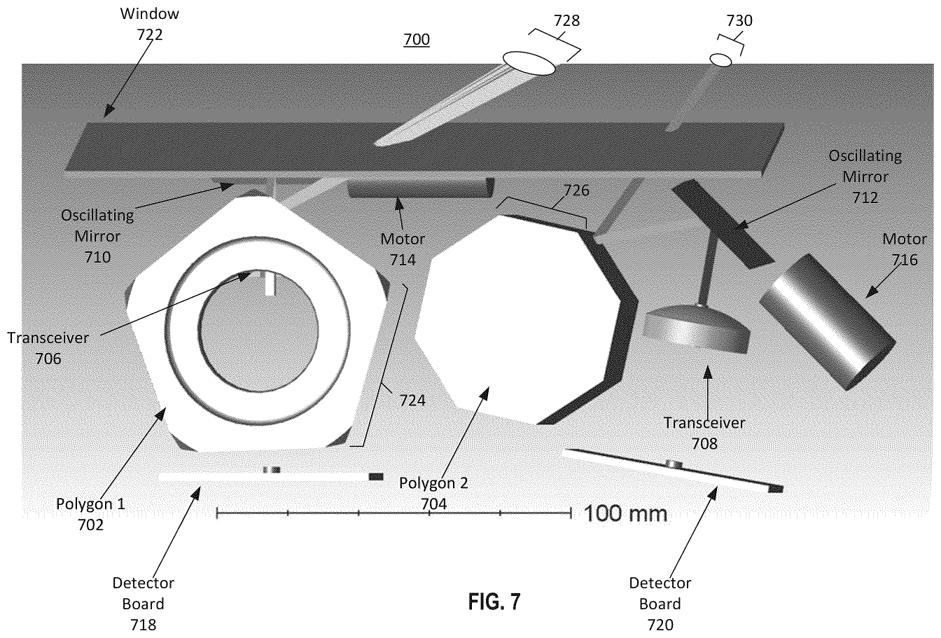

FIG. 7 is a diagram illustrating an example multiple scanner LiDAR system. Multiple scanner LiDAR system 700 comprises polygons 702 and 704, transceivers 706 and 708, oscillating mirrors 710 and 712 with steering mechanisms comprising corresponding motors 714 and 716, and detectors 718 and 720. In some embodiments, LiDAR system 700 may comprise a housing having a window 722 through which optical scanning signals may be transmitted and return signals resulting from the transmitted optical scanning signals may be received, e.g., return signals from a target object. Each optical scanner of the one or more optical scanners may comprise one or more light steering optics configured to scan one or both of horizontal and vertical directions of a FOV. For example, the optical scanners may be configured to scan different FOVs using different output light beams of the plurality of output light beams. Although the components and configuration shown in FIG. 7 is exemplary, it is understood that LiDAR system 700 can include additional and/or alternative laser sources, control electronics, transmitters, receivers, and/or steering mechanisms that, e.g., may be shared or dedicated to respective optical scanners.

LiDAR system 700 is a dual scanner LiDAR system comprising a first optical scanner and a second optical scanner. The first optical scanner comprises first polygon 702, transceiver 706, oscillating mirror 710 with a steering mechanism comprising corresponding motor 714, and detectors 718. The second optical scanner comprises second polygon 704, transceiver 708, oscillating mirror 712 with a steering mechanism comprising corresponding motor 716, and detector 720. A multiple seed laser device, as described in detail below, can be configured to provide a plurality of output light beams to the optical scanners of LiDAR system 700. For example, each of the plurality of output light beams from a multiple-seed laser device may be provided to a respective optical scanner of LiDAR system 700.

In one embodiment, the first optical scanner may further comprise a first oscillating mirror 710/corresponding motor 714 positioned lower than the first polygon mirror 702 in a vertical direction (i.e., on a different vertical plane) to direct a first output light beam to the first polygon mirror 702; where the second optical scanner further comprises a second oscillating mirror 712/corresponding motor 716 positioned generally on a same horizontal plane as the second polygon mirror 704 (i.e., positioned to the side of second polygon mirror 704) to direct a second output light beam to the second polygon mirror 704. In some embodiments, each of the plurality of output light beams may be provided to a respective transmitter channel of a plurality of transmitter channels, where the plurality of transmitter channels shares a single optical scanner of the LiDAR system 700.

In one embodiment, the first optical scanner of LiDAR system 700 comprises a first polygon mirror 702 and the second optical scanner of LiDAR system 700 comprises a second polygon mirror 704, where the width of a facet 724 of the first polygon mirror 702 is greater than the width of a facet 726 of the second polygon mirror 704, such that the scanning range of the horizontal direction of the first polygon mirror 702 is greater than that of the second polygon mirror 704. Likewise, the height of a facet 724 of the first polygon mirror 702 may be smaller than the height of a facet 726 of the second polygon mirror 714 such that the scanning range of the vertical direction of the first polygon mirror 702 is smaller than the scanning range of the vertical direction of the second polygon mirror 704. For example, the second polygon mirror 704 may be about twice as tall as the first polygon mirror 702 and about half as wide as the first polygon mirror 702.

Continuing to refer to FIG. 7, the first optical scanner is configured to scan a first FOV 728 to generate a first scanning data, and the second optical scanner is configured to scan a second FOV 730 to generate a second scanning data. For LiDAR applications, it is beneficial to have two scanners with two different wavelengths, one to cover the overall FOV and the other to cover a smaller ROI region. Therefore, the resolution of the second scanning data may be greater than the resolution of the first scanning data. For example, the first FOV 728 may be an overall FOV of the LiDAR system 700 and the second FOV 730 may be directed to a region-of-interest (ROI) area.

In various embodiments, LiDAR system 700 may comprise one or more additional windows; transceivers; detectors; optics, etc. In addition, LiDAR system 700 may comprise one or more bandpass filters (not shown). For example, each of the bandpass filters may be configured to filter out-of-bandwidth light for a corresponding scanner, thereby reducing optical interference between optical scanners. Further, LiDAR system 700 may comprise one or more processors (not shown) configured to process and merge output data provided by the one or more optical scanners to provide a unified point-cloud data output. For example, a vehicle comprising LiDAR system 700 make take an action based on the unified point-cloud data output.

Typically, a pulsed fiber laser source includes a single wavelength seed laser. Therefore, seed laser pre-amplifiers can be configured to provide a plurality of amplified output light beams to the optical scanners of LiDAR system 700. For example, each of the plurality of amplified output light beams from a plurality of seed laser pre-amplifiers may be provided to a respective optical scanner of LiDAR system 700.

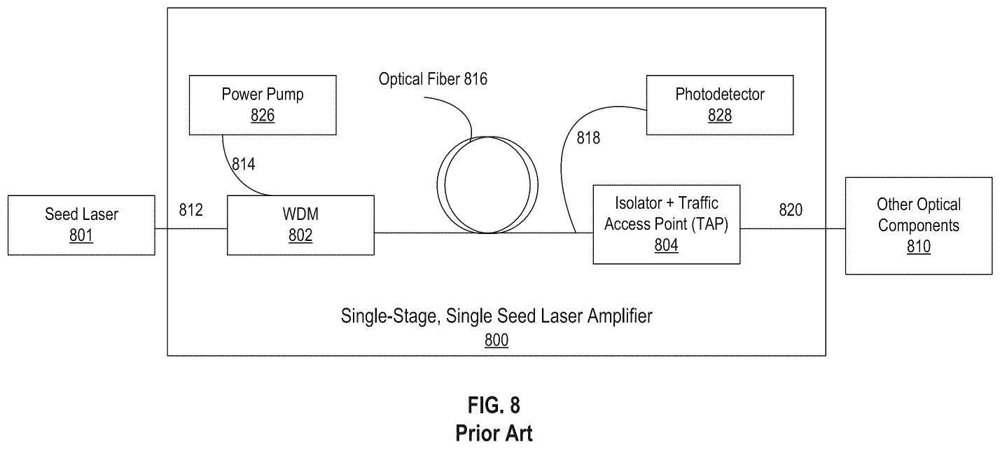

FIG. 8 illustrates a conventional single-stage, single seed laser amplifier 800. Amplifier 800 comprises a wavelength division multiplexer (WDM) 802, an optical power pump 826, an optical fiber 816, an optical isolator and TAP (traffic access point) unit 804, and a photodetector 828. Amplifier 800 receives optical signals provided by seed laser 801 via optical fiber 812. These optical signals are to be amplified by single stage pre-amplifier 800. Optical power pump 826 (e.g., laser diodes) provides a pump laser, which is carried by optical fiber 814. The optical signals to be amplified and the pump laser are multiplexed by, for example, WDM 802 into a doped optical fiber 816. The optical signals are thus amplified through interaction with the dopant ions in optical fiber 816. Amplification is achieved by stimulated emission of photons from dopant ions in optical fiber 816. In particular, the pump laser excites ions into an upper energy level from where they can decay via stimulated emission of a photon at the signal wavelength back to a lower energy level.

The doped optical fiber 816 is optically coupled to optical isolator and traffic access point (TAP) unit 804 and photodetector 828. The optical isolator and TAP unit 804 includes an optical isolator that allows optical signal to travel only in one direction. For example, the optical isolator allows the amplified optical signals to travel from optical fiber 816 to other optical components 810 but not backward. Thus, the optical isolator prevents undesired feedback or reflection. The TAP is an access point that provides real-time monitoring of the optical signals. Photodetector 828 receives at least a portion of the amplified optical signals via optical fiber 818 and provides measurements of the output power of the amplified optical signals. The amplified optical signals pass through isolator and TAP unit 804 and are delivered to other optical components 810 (e.g., lens, mirrors, etc.).

While amplifier 800 can be acceptable for single seed laser source amplification, it is beneficial to have two or more scanners with two or more different wavelengths for various LiDAR applications, e.g., one scanner to cover an overall FOV and one or more other scanners to cover a smaller ROI region or regions. Typically, seed laser source amplification for such applications requires a costly solution with two or more separate laser sources having corresponding separate amplifier sections. However, instead of having two separate laser sources, multiple (two or more) seed lasers can share the same amplifier sections as described below. This solution can save space and cost in a multiple scanner LiDAR system and can also support flexible device configurations.

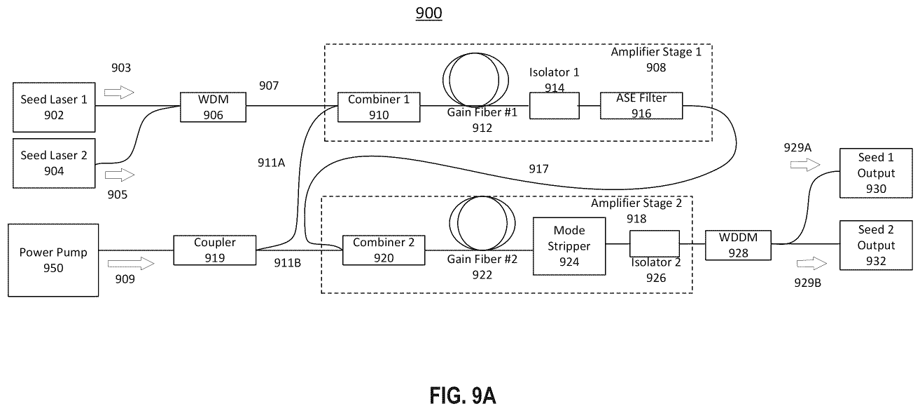

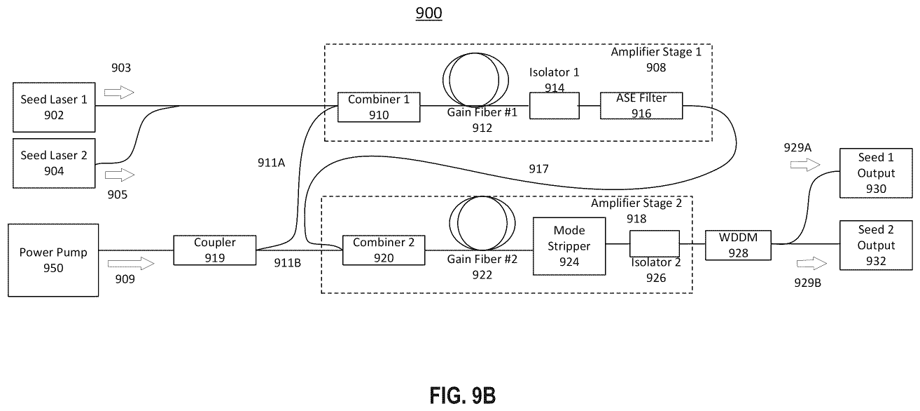

FIG. 9A is a block diagram illustrating an example of a multiple-seed laser device 900 according to some embodiments. Multiple-seed laser device 900 comprises seed lasers 902 and 904, WDM 906, optical power pump 950, light coupling unit (coupler) 919, first power amplification stage 908 comprising first combiner 910, first gain fiber 912, first isolator 914, and ASE filter 916, second power amplification stage 918 comprising second combiner 920, second gain fiber 922, mode stripper 924, and second isolator 926, wave division demultiplexer 928, amplified output light beam paths (e.g., fiber based delivering media) 930 and 932, and optical paths/fiber-based delivering media 903, 905, 907, 909, 911A and 911B, 917, and 929A and 929B. For example, all or part of device 900, e.g., seed lasers 902 and 904, may be included within a LiDAR system housing, e.g., comprising LiDAR device 700 described above. In some embodiments, one or more thermal electric coolers (not shown) may be installed to control the operating temperature of one or more active components of device 900. For example, one thermal electric cooler may be packaged together with seed laser 902 and another thermal electric cooler may be packaged with seed laser 904, so that the temperature and the emitting laser wavelength of the seed lasers can be controlled independently. It typically takes about 0.2 W of electric power to cool down the seed lasers from ambient temperatures as high as 105° C.

Seed lasers 902 and 904 may be any kind of laser with different wavelengths. For example, when the plurality of seed lasers comprise a first seed laser and a second seed laser, the first seed laser may be configured to provide a first seed light beam having a wavelength centered at a selected first wavelength (e.g., 1550 nm), and the second seed laser may be configured to provide a second seed light beam having a wavelength of centered at a selected second wavelength (e.g., 1535 nm), where the selected first wavelength and second wavelength are different wavelengths. Likewise, the pump laser can be any laser type having a wavelength that is lower than the seed laser output wavelengths. For example, when the first seed laser is configured to provide a first seed light beam centered at 1550 nm, and the second seed laser is configured to provide a second seed light beam having a wavelength of centered at 1535 nm, the wavelength of the pump laser 950 may be 940 nm. Further, the embodiments herein should not be construed as being limited to fiber lasers and fiber amplifiers. Other types of lasers and amplifiers (e.g., diode lasers and semiconductor optical amplifiers) can also be used. In addition, the embodiments can be realized with free-space optics and/or optical fibers.

In some embodiments, the power ratio between the two frequencies of the two seed lasers can depend on a time delay between the two seed pulses entering the amplification medium (e.g., a time delay of about 100 nanoseconds). In such cases, it is possible to delay one of the seed pulses, so that they are interleaved in time. For example, the time delay between the two seed lasers can be optimized to reduce non-linear effects (e.g., wavelength drifting, spectral broadening, etc.) that might otherwise cause the first arriving seed pulse to deplete the gain. Further, the spectrum may be broadened if the output power intensity is too high (e.g., excess output power intensity caused by high seed power, high gain, high pump power, etc.), and a bandpass filter (not shown) may be included to start to cut off power in the event of an excessive output power intensity condition.

In an embodiment, jitter between the seed lasers may be controlled to be less than a threshold value (e.g., 100 pico seconds). For example, a polarization combiner (not shown) may be used for beam combining. The polarization combiner can have, e.g., less than 20 dB extinction on the other wavelength. Further, in some embodiments, polarization-maintaining fiber may be used in the laser device 900.

Seed lasers 902 and 904 may each include a master oscillator that can provide continuous wave laser light or pulsed laser light. For example, seed lasers 902 and 904 may comprise one or more pulsed seed lasers that can be configured to generate pulsed laser light having one or more wavelengths (e.g., 1535 nm and 1550 nm). For example, multiple-seed laser device 900 may comprise a first seed laser, e.g., seed laser 902, configured to emit light pulses at a first pulse repetition rate, and a second seed laser, e.g., seed laser 904, configured to emit light pulses at a second pulse repetition rate while the first seed laser is emitting light pulses at the first pulse repetition rate, the second pulse repetition rate being different from the first pulse repetition rate. For example, the first seed laser and the second seed laser may be synchronized such that when the second seed laser emits light pulses, the first seed laser does not emit light pulses. Further, the first seed laser may be controlled, e.g., by one or more laser emission controllers (not shown), to continuously emit light pulses at the first pulse repetition rate, and the second seed laser may be controlled, e.g., by the one or more laser emission controllers (not shown), to intermittently emit light pulses at the second pulse repetition rate during one or more time intervals. For example, the one or more time intervals may be determined based on requirements of scanning one or more regions of interest (ROI) in a LiDAR system. Thus, the laser device 900 can be operated under a dual output mode or a single output mode (e.g., by turning off one or more seed lasers). For example, when there is only one operational seed laser (wavelength) at a time, the pump power can be reduced. Likewise, when one or more seed lasers are switched off, the pump current can be reduced.

WDM 906 includes a multiplexer that multiplexes or combines multiple input optical signals and delivers the combined signals to a single optical fiber. The multiple input optical signals are carried by input laser light having different wavelengths. The input laser light having different wavelengths can be delivered by multiple input optical fibers. In some embodiments, WDM 906 can be used to tune the wavelengths of input optical signals and/or to provide temperature tuning of input optical signals.

In one embodiment, WDM 906 is optically coupled to first seed laser 902 and second seed laser 904 via optical paths 903 and 905, respectively. Optical paths 903 and 905 can include an optical fiber and/or one or more free-space optics (e.g., lens) for delivering the seed laser light from seed lasers 902 and 904 to WDM 906. In addition to being coupled to seed lasers 902 and 904, the output end of WDM 906 is optically coupled to a first end (e.g., the front end) of first power amplification stage 908 via optical path 907.

FIG. 9B is a block diagram illustrating an example of a multiple-seed laser device 900 according to some embodiments where seed lasers 902 and 904 are optically coupled to a first end (e.g., the front end) of first power amplification stage 908 directly via optical paths 903 and 905, respectively, without employing a WDM. This can be done either by placing seed laser 902 and 904 inside a single fiber-coupled package, or by combining the seed laser outputs with a fiber coupler. In some embodiments, the plurality of seed lasers is configured to emit the multiple seed light beams in a synchronized manner, e.g., to obtain at least one of a substantially stable pump power distribution or to reduce interference between the at least two seed light beams having different wavelengths. For example, where the plurality of seed lasers comprises a first seed laser and a second seed laser, e.g., seed lasers 902 and 904, the first seed laser and the second seed laser may be configured to emit light pulses in an alternating manner. In such case, a power ratio between the first seed laser and second seed laser may be configured according to a time delay between a seed pulse of the first seed laser and a corresponding seed pulse of the second seed laser. For example, the time delay may be optimized to reduce one or more non-linear effects associated with the first seed laser or the second seed laser. Moreover, a jitter between the first seed laser and the second seed laser may be controlled in a similar manner to be less than a jitter threshold value.

Referring back to the multiple-stage amplifier in FIG. 9A, multiple-seed laser device 900 comprises an amplifier that may be a single-stage amplifier, or a multiple-stage amplifier comprising at least a first amplification stage and a second amplification stage as shown in FIG. 9A. Therefore, although the two-stage amplifier shown in FIG. 9A is exemplary, other amplifier configurations are possible within the scope of the various embodiments. For example, the amplifier may be a three-, four-, or five-stage amplifier while remaining in keeping with the various embodiments herein. Further, when the amplifier comprises one or more additional power amplification stages, an optical power pump may be configured to provide one or more portions of the pump power to the corresponding one or more additional power amplification stages.

In the configuration shown in FIG. 9A, optical power pump 950 generates pump laser light to provide pump power. Optical power pump 950 can provide pump laser light using, for example, one or more laser diodes. In one embodiment, optical power pump 950 can also be configured to provide pump laser light having any desired wavelength (e.g., 915 nm, 940 nm, 980 nm, 1480 nm, or the like). For example, optical power pump 950 may be a 400 mW single mode pump producing pump laser light having a 980 nm wavelength. The pump power provided by optical power pump 950 is delivered to light coupling unit 919 via optical path 909 (e.g., an optical fiber). In one embodiment, light coupling unit 919 can include an assembly of one or more WDMs and/or combiners.

In an embodiment, the power pump 950 may be configured to provide a first portion of the pump power to the first amplification stage 908 and a second portion of the pump power to the second amplification stage 918. For example, the power pump 950 may be controlled in an open loop manner according to desired pump current level. For example, open loop control circuitry may be used to control the pump current to enable fast switching (on and off) of the laser device output. In the two-stage amplifier shown in FIG. 9A, light coupling unit 919 delivers the pump laser light to first ends (e.g., the front ends) of power amplification stages 908 and 918 via fiber-based delivering media 911A and 911B. That is, a portion of the pump power is delivered for use in first power amplification stage 908 for amplification of seed laser light provided by one or more of seed lasers 902 and 904, and another portion of the pump power is used in second power amplification stage 918 for further amplification of a first amplified laser light output received from first power amplification stage 908. First and second combiners 910 and 920 combine seed laser light with the portion of the pump power (in the form of pump laser light) delivered by fiber-based delivering media 911A and 911B in power amplification stages 908 and 918, respectively.

In device 900, power amplification stages 908 and 918 each comprise a fiber-based amplification medium (e.g., gain fibers 912 and 922) such as a rare earth doped optical fiber. Such an optical fiber can be, for example, a fiber doped with at least one of Ytterbium (Yb), Erbium (Er), Thulium (Tm), or Neodymium (Nd). The fiber-based amplification media included in power amplification stages 908 and 918 may be the same or different. For example, each of amplification stages 908 and 918 may comprise a 1550 nm single mode Er-doped optical fiber. It is understood that power amplification stages 908 and 918 can include any type of doped medium to produce output light having any desired wavelengths (e.g., 1030 nm, 1064 nm, 1530 nm, 1550 nm, 2 μm, or the like). Further, the fiber-based amplification media used in the power amplification stages (e.g., stages 908 and 918) can comprise single mode fibers, large mode area (LMA) fibers, double-clad fibers, or the like.

The first amplification stage 908 comprises a first optical combiner 910 configured to combine the first portion of the pump power obtained via fiber-based delivering media 911A with the seed light beams obtained via optical path 907. For example, the light coupling unit 919 may be a polarization beam splitter, where one or more of the optical paths/fiber-based delivering media of device 900, e.g., optical paths/fiber-based delivering media 903, 905, 907, 909, 911A and 911B, 917, and 929A and 929B, further comprises polarization maintaining fiber. As shown in FIG. 9A, light coupling unit 919 is optically coupled to the front end of first power amplification stage 908, e.g., first optical combiner 910. Thus, the combined seed laser light and the portion of the pump power delivered by fiber-based delivering medium 911A is delivered to power amplification stage 908. The portion of the pump power delivered by fiber-based delivering medium 911A can thus be used to amplify the seed laser light in power amplification stage 908.

The first amplification stage further comprises a first amplification medium. For example, the first amplification stage 908 may be a fiber-based amplifier having a first gain fiber 912 configured to amplify, using the first portion of the pump power, the multiplexed seed light beams to obtain first amplified light beams. Amplification can be obtained by stimulated emission of photons from dopant ions in the doped optical fiber used in power amplification stage 908. In particular, the portion of the pump power delivered by fiber-based delivering medium 911 excites ions into an upper energy level from where they can decay via stimulated emission of a photon at the desired signal wavelength back to a lower energy level. As a result, power amplification stage 908 is a first amplification stage that amplifies the seed laser light from the multiple seed lasers, e.g., seed lasers 902 and 904, either collectively or individually (e.g., in an alternating pulse configuration) and generates the first amplified laser light.

First power amplification stage 908 further comprises an optical isolator 914 optically coupled to the output of gain fiber 912. Optical isolator 914 can pass optical signals from its input to its output but not backward. Thus, optical isolator 914 prevents undesired feedback or reflection. As a result, the first amplified laser light generated by gain fiber 912 may only propagate forward, but not backward.

First power amplification stage 908 further comprises an amplified spontaneous emission (ASE) filter 916 optically coupled to the output of optical isolator 914. ASE filter 916 is configured to remove at least a portion of ASE noise in the first amplification stage. A second end (e.g., the backend) of the first power amplification stage 908, e.g., the output of ASE filter 916, is optically coupled to a first end (e.g., the front end) of second power amplification stage 918 via optical path 917 to deliver the first amplified laser light output of the first power amplification stage 908 to second power amplification stage 918.

The second amplification stage 918 comprises a second optical combiner 920 configured to combine the second portion of the pump power obtained via fiber-based delivering media 911B with the first amplified light beams obtained via optical path 917. For example, the second optical combiner 920 may be a polarization combiner, where one or more of the optical paths/fiber-based delivering media of device 900, e.g., optical paths/fiber-based delivering media 903, 905, 907, 909, 911A and 911B, 917, and 929A and 929B, further comprises polarization maintaining fiber.

The second amplification stage 918 further comprises a second amplification medium. For example, the second amplification stage 918 may be a fiber-based amplifier having a second gain fiber 922 configured to amplify, using the second portion of the pump power, the first amplified light beams to obtain second amplified light beams. As discussed above, second power amplification stage 918 uses a portion of the pump power provided by optical power pump 950, delivered via light coupling unit 919, to further amplify the first amplified laser light received from the first power amplification stage 908. In particular, a portion of the pump power provided by optical power pump 950 is absorbed by the doped optical fiber, e.g., gain fiber 922, of power amplification stage 918 to excite dopant ions. The decay of the excited ions from an upper energy level to a lower energy level generates a second amplified laser light having the desired signal wavelength (e.g., 1550 nm).

In some embodiments, the first portion of the pump power may be less than the second portion of the pump power. In one example, about 50-90% (e.g., 70%) of the pump power provided by the optical power pump 950 is used for the second stage amplification performed by power amplification stage 918. The remaining about 10-50% (e.g., 30%) of the pump power is delivered to the power amplification stage 908 and is used for the first stage amplification. Thus, the configuration of device 900 shown in FIG. 9A can use a single optical power pump to provide two stage amplifications. Device 900 therefore makes more efficient use of the pump power and reduces energy waste by delivering the portion of the pump power that is unused by the second amplification stage to the first amplification stage. In one example, the output power of the output signal from device 900 is about 40% higher than a single stage amplifier such as the one shown in FIG. 8. A higher output power enables the signal light to travel to a far-distance object. As a result, a LiDAR device using such a signal light can detect object that is located far away from the device (e.g., more than about 100-150 meters).

Furthermore, because device 900 has two amplification stages, each stage can have a smaller power gain than that of a single stage amplifier while still achieving the same output power. For example, as shown in Table 1 below, the first amplification stage of a two-stage amplification device may have an output power of about 1-3 mW, and the second amplification stage may have an output power of about 100 mW. Table 1 also shows that the maximum power gain of any one of the two amplification stages in device 900 is about 18-20 dB, compared to about 34 dB for the single-stage simplification device 800. In some embodiments, the first amplification stage 908 may have a higher power gain than that of the second amplification stage 918, or vice versa. An amplification stage having a smaller power gain facilitates reducing ASE and improves the signal-to-noise ratio of amplification device 900. It is understood that device 900 may be configured such that more or less of pump power can be delivered to the first power amplification stage (e.g., stage 908) and therefore, the output power of the first amplification stage and the second amplification stage may vary from those shown in Table 1.

TABLE 1

| | Output | |
|---|---|---|
| | Power (mW) | Gain |
| Single Stage Amplifier | 100 | About 2500x or 34 dB |
| Double Stage Amplifier, first | 1-3 | Less than or equal to about |
| amplification stage | | 75x or 18 dB |
| Double Stage Amplifier, | 100 | Less than or equal |
| second amplification stage | | to 100x or 20 dB |

In an embodiment, the second amplification stage 918 may further comprise at least one of an optical mode stripper 924 coupled to the output of gain fiber 922. The optical mode stripper is configured to remove at least a portion of residual pump light from the second amplified laser light.

In an embodiment, the second amplification stage 918 may further comprise second optical isolator 926, e.g., coupled to the output of optical mode stripper 924. Second optical isolator 926, optionally in combination with a second ASE filter (not shown), may be configured to remove at least a portion of ASE noise in the second amplification stage 918.

In an embodiment, device 900 further comprises a demultiplexing or distributing WDM or wavelength divisional demultiplexer (WDDM) 928 coupled to the output of the second amplification stage 918, e.g., the output of second optical isolator 926. For example, a WDDM can include a splitter to demultiplex or distribute the combined optical signals carried by a single optical fiber to multiple output optical signals. The multiple output optical signals are carried by output laser light having multiple wavelengths. These output laser light having multiple wavelengths can be carried by multiple output optical fibers. In device 900, WDDM 928 is configured to demultiplex the amplified light beams to obtain a plurality of output light beams, e.g., output light beams 930 and 932, to be delivered to other optical components (e.g., polygon mirror, collimation lens, or the like) corresponding to the first and second seed lasers 902 and 904 via optical paths 929A and 929B, respectively. Optical paths 929A and 929B may include optical fiber and/or free-space optical components. For example, the output light beams 930 and 932 may be provided to optical components of a LiDAR system, e.g., LiDAR system 700. For example, the output light beams may be provided to a respective optical scanner of the optical scanners of LiDAR system 700.

One skilled in the art will appreciate that other configurations of the power pump with respect to the one or more amplification stages are possible in keeping with the embodiments described herein. Moreover, different configurations of the power pump with respect to the amplification stages are described in more detail in U.S. patent application Ser. No. 17/724,251, the content of which is incorporated herein by reference in its entirety for all purposes.

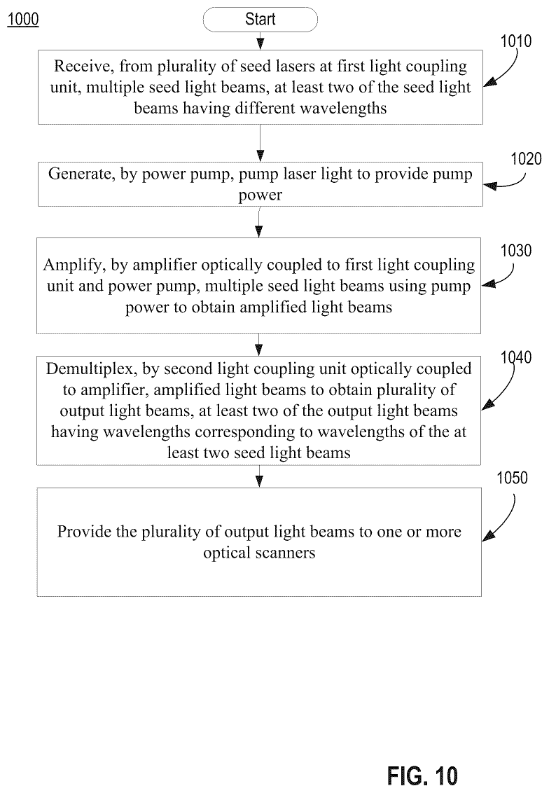

FIG. 10 is a flow diagram illustrating an example method 1000 of providing laser light from multiple seed lasers to a LiDAR system. Method 1000 can be performed by any of the multiple seed laser devices described above, including device 900. As shown in FIG. 10, in step 1010, the multiple-seed laser device receives, from a plurality of seed lasers at a first light coupling unit (e.g., combiner 910), multiple seed light beams, at least two of the seed light beams having different wavelengths. In step 1020, a power pump of the laser device generates pump laser light to provide pump power. In step 1030, an amplification device (e.g., comprising first and second amplification stages 908 and 918) of the multiple-seed laser device that is optically coupled to the first light coupling unit and the power pump, amplifies the multiple seed light beams using the pump power to obtain amplified light beams. In step 1040, a wave division demultiplexer (e.g., WDDM 928) optically coupled to the two-stage amplification device of the laser device, demultiplexes the amplified light beams to obtain a plurality of output light beams, at least two of the output light beams having wavelengths corresponding to the wavelengths of the at least two seed light beams. For a two-stage amplification device, the second amplified laser light may comprise the output light beams which, upon being demultiplexed, have a desired at least first and second output wavelength and power corresponding to the respective input at least two of the seed light beams having different wavelengths. In step 1050, the wave division demultiplexer provides the plurality of output light beams to optical scanner circuitry, e.g., one or more optical scanners.

In some embodiments, method 1000 further includes steps of (not shown) combining the seed laser light and pump laser light corresponding to the first portion of the pump power to generate combined light; and delivering the combined light to the first power amplification stage. As shown in FIGS. 9A and 9B, first power amplification stage 908 may comprise first combiner 910. Method 1000 can further include delivering the multiple seed light beams to a first end of the first power amplification stage; delivering a first portion of the pump laser light corresponding to the first portion of the pump power to the first end of the first power amplification stage; and combining the multiple seed light beams and the first portion of the pump laser light at the first end of the first power amplification stage.

In some embodiments, method 1000 further includes steps of (not shown) delivering the first amplified laser light from a second end of the first amplification stage to a first end of a second power amplification stage; and delivering the pump laser light to a first end of the second power amplification stage, where the first end and the second end of the first power amplification stage are different ends of the first power amplification stage.

In some embodiments, method 1000 further includes steps of (not shown) combining the first amplified laser light and the pump laser light to generate combined light; and delivering the combined light to the second power amplification stage. As shown in FIGS. 9A and 9B, second power amplification stage 918 may comprise second combiner 920.

In some embodiments, method 1000 further includes steps of (not shown) delivering the first amplified laser light to a first end of the second power amplification stage; and delivering a second portion of the pump laser light corresponding to the second portion of the pump power to the first end of the second power amplification stage, where the first end and the second end of the first power amplification stage are different ends of the second power amplification stage.

The foregoing specification is to be understood as being in every respect illustrative and exemplary, but not restrictive, and the scope of the invention disclosed herein is not to be determined from the specification, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

What is claimed is:

1. A laser device for providing light to a light ranging and detection (LiDAR) system, the device comprising:
a plurality of seed lasers configured to provide multiple seed light beams, at least two of the seed light beams having different wavelengths;
a first light coupling unit optically coupled to the plurality of seed lasers and configured to receive the multiple seed light beams;
an amplifier optically coupled to the first light coupling unit to receive the multiple seed light beams;
a power pump configured to provide pump power to the amplifier, wherein the amplifier amplifies the multiple seed light beams using the pump power to obtain amplified light beams; and
a second light coupling unit configured to demultiplex the amplified light beams to obtain a plurality of output light beams, at least two of the output light beams having wavelengths corresponding to the wavelengths of the at least two seed light beams.

2. The device of claim 1, wherein the first light coupling unit is configured to multiplex the multiple seed light beams.

3. The device of claim 1, further comprising a housing, wherein the plurality of seed lasers is included in the housing.

4. The device of claim 1, wherein the plurality of seed lasers comprises a first seed laser and a second seed laser, the first seed laser being configured to provide a first seed light beam having a wavelength centered at 1550 nm, the second seed laser being configured to provide a second seed light beam having a wavelength of centered at 1535 nm.

5. The device of claim 1, further comprising a plurality of optical fibers or free-space optics configured to couple the plurality of seed lasers to the first light coupling unit.

6. The device of claim 1, wherein the first light coupling unit comprises a wavelength division multiplexer.

7. The device of claim 1, wherein the amplifier is a single-stage amplifier.

8. The device of claim 1, wherein the amplifier is a multiple-stage amplifier comprising at least a first amplification stages and a second amplification stage.

9. The device of claim 8, wherein the power pump is configured to provide a first portion of the pump power to the first amplification stage and a second portion of the pump power to the second amplification stage.

10. The device of claim 9, wherein the first portion of the pump power is less than the second portion of the pump power.

11. The device of claim 9, wherein the first amplification stage comprises:
a first optical combiner configured to combine the first portion of the pump power with the multiplexed seed light beams; and
a first amplification medium configured to amplify, using the first portion of the pump power, the multiplexed seed light beams to obtain first amplified light beams.

12. The device of claim 11, wherein the first optical combiner is a polarization combiner, the device further comprises a polarization maintaining fiber.

13. The device of claim 11, wherein the first amplification stage further comprises at least one of:
a first optical isolator; and
a first filter configured to remove at least a portion of amplified spontaneous emission (ASE) noise in the first amplification stage.

14. The device of claim 11, wherein the second amplification stage comprises:
a second optical combiner configured to combine the second portion of the pump power with the first amplified light beams; and
a second amplification medium configured to amplify, using the second portion of the pump power, the first amplified light beams to obtain second amplified light beams.

15. The device of claim 14, wherein the second optical combiner is a polarization combiner, the device further comprises a polarization maintaining fiber.

16. The device of claim 14, wherein the second amplification stage further comprises at least one of:
a second optical isolator;
an optical mode stripper configured to remove at least a portion of residual pump light; and
a second filter configured to remove at least a portion of amplified spontaneous emission (ASE) noise in the second amplification stage.

17. The device of claim 8, wherein the first amplification stage has a higher power gain than that of the second amplification stage.

18. The device of claim 8, wherein the amplifier comprises one or more additional power amplification stages and wherein the power pump is configured to provide one or more portions of the pump power to the corresponding one or more additional power amplification stages.

19. The device of claim 1, wherein the amplifier is a fiber-based amplifier.

20. The device of claim 1, wherein the plurality of seed lasers are configured to emit the multiple seed light beams in a synchronized manner to obtain at least one of a substantially stable pump power distribution or reducing interference between the at least two seed light beams having different wavelengths.

21. The device of claim 1, wherein the plurality of seed lasers comprises a first seed laser and a second seed laser, the first seed laser and the second seed laser being configured to emit light pulses in an alternating manner.

22. The device of claim 21, wherein a power ratio between the first seed laser and second seed laser is configured according to a time delay between a seed pulse of the first seed laser and a corresponding seed pulse of the second seed laser.

23. The device of claim 22, wherein the time delay is optimized to reduce one or more non-linear effects associated with the first seed laser or the second seed laser.

24. The device of claim 21, wherein a jitter between the first seed laser and the second seed laser is controlled to be less than a jitter threshold value.

25. The device of claim 1, wherein the plurality of seed lasers comprises:
a first seed laser configured to emit light pulses at a first pulse repetition rate;
a second seed laser configured to emit light pulses at a second pulse repetition rate while the first seed laser is emitting light pulses at the first pulse repetition rate, the second pulse repetition rate being different from the first pulse repetition rate.

26. The device of claim 25, wherein the first seed laser and the second seed laser are synchronized such that when the second seed laser emits light pulses, the first seed laser does not emit light pulses.

27. The device of claim 25, wherein the first seed laser is controlled to continuously emit light pulses at the first pulse repetition rate, and wherein the second seed laser is controlled to intermittently emit light pulses at the second pulse repetition rate during one or more time intervals.

28. The device of claim 27, wherein the one or more time intervals are determined based on requirements of scanning one or more regions of interest (ROI).

29. The device of claim 1, wherein the second light coupling unit comprises a second wavelength divisional multiplexer configured to demultiplex the amplified light beams to obtain the plurality of output light beams.

30. The device of claim 1, wherein at least one of the plurality of seed lasers is a pulsed seed laser.

31. The device of claim 1, wherein the power pump is controlled in an open loop manner according to predetermined pump current level.

32. The device of claim 1, further comprising a thermal electric cooler.

33. A light ranging and detection (LiDAR) system comprising:
one or more optical scanners; and
a fiber-based laser device comprising:
a plurality of seed lasers configured to provide multiple seed light beams, at least two of the seed light beams having different wavelengths;
a first light coupling unit optically coupled to the plurality of seed lasers and configured to receive the multiple seed light beams;
an amplifier optically coupled to the first light coupling unit to receive the multiple seed light beams;
a power pump configured to provide pump power to the amplifier, wherein the amplifier amplifies the multiple seed light beams using the pump power to obtain amplified light beams; and
a second light coupling unit configured to demultiplex the amplified light beams to obtain a plurality of output light beams, at least two of the output light beams having wavelengths corresponding to the wavelengths of the at least two seed light beams, the fiber-based laser device being configured to provide the plurality of output light beams to the one or more optical scanners.

34. The system of claim 33, wherein each of the plurality of output light beams is provided to a respective optical scanner of one or more optical scanners, each optical scanner of the one or more optical scanners comprising one or more light steering optics configured to scan one or both of horizontal and vertical directions of a field-of-view (FOV).

35. The system of claim 33, wherein at least two different optical scanners of the one or more optical scanners are configured to scan different FOVs using different output light beams of the plurality of output light beams.

36. The system of claim 33 wherein the one or more optical scanners comprise a first optical scanner and a second optical scanner, the first optical scanner comprising a first polygon mirror and the second optical scanner comprising a second polygon mirror,
wherein the width of a facet of the first polygon mirror is greater than a facet of the second polygon mirror such that the scanning range of the horizontal direction of the first polygon mirror is greater than that of the second polygon mirror; and
wherein the height of a facet of the first polygon mirror is smaller than a facet of the second polygon mirror such that the scanning range of the vertical direction of the first polygon mirror is smaller than that of the second polygon mirror.

37. The system of claim 36, wherein the second polygon mirror is about twice as tall as the first polygon mirror and about half as wide as the first polygon mirror.

38. The system of claim 36, wherein the first optical scanner is configured to scan a first FOV to generate a first scanning data, and the second optical scanner is configured to scan a second FOV to generate a second scanning data, the resolution of the second scanning data being greater than the resolution of the first scanning data.

39. The system of claim 38, wherein the first FOV is an overall FOV of the LiDAR system and the second FOV is an ROI area.

40. The system of claim 36, wherein the first optical scanner further comprises a first oscillating mirror positioned lower than the first polygon mirror in the vertical direction to direct a first output light beam to the first polygon mirror; wherein the second optical scanner further comprises a second oscillating mirror positioned on the side of the second polygon mirror to direct a second output light beam to the second polygon mirror.

41. The system of claim 33, wherein each of the plurality of output light beams is provided to a respective transmitter channel of a plurality of transmitter channels, the plurality of transmitter channels sharing a single optical scanner of the LiDAR system.

42. The system of claim 33, further comprising one or more of:
a window;
one or more transceivers;
one or more detectors; and
one or more optics.

43. The system of claim 33, further comprising one or more bandpass filters, each of the bandpass filters being configured to filter out-of-bandwidth light for a corresponding scanner, thereby reducing optical interference between optical scanners.

44. The system of claim 33, further comprising a processor configured to process and merge output data provided by the one or more optical scanners to provide a unified point-cloud data output.

45. A vehicle comprising a light range and detection (LiDAR) system of claim 33.

46. A method of providing laser light to a light ranging and detection (LiDAR) system, the device comprising:
receiving, from a plurality of seed lasers at a first light coupling unit, multiple seed light beams, at least two of the seed light beams having different wavelengths;
generating, by a power pump, pump laser light to provide pump power;
amplifying, by an amplifier optically coupled to the first light coupling unit and the power pump, the multiple seed light beams using the pump power to obtain amplified light beams;
demultiplexing, by a second light coupling unit optically coupled to the amplifier, the amplified light beams to obtain a plurality of output light beams, at least two of the output light beams having wavelengths corresponding to the wavelengths of the at least two seed light beams; and
providing the plurality of output light beams to one or more optical scanners.
